(19) United States
(12) Patent Application Publication
(10) Pub. No.: US 2016/0118855 A1
(43) Pub. Date: Apr. 28, 2016

(54) Motor, Positioning Device, Conveyance Device

(71) Applicant: NSK LTD., Shinagawa-ku, Tokyo (JP)

(72) Inventors: Masayuki MARUYAMA, Kanagawa (JP); Yusuke OTA, Kanagawa (JP); Kazunori KOIZUMI, Kanagawa (JP); Hayao WATANABE, Kanagawa (JP); Toshinori SATOU, Kanagawa (JP)

(73) Assignee: NSK LTD., Shinagawa-ku, Tokyo (JP)

(21) Appl. No.: 14/892,442

(22) PCT Filed: May 7, 2014
(86) PCT No.: PCT/JP2014/002427

§ 371 Date: Nov. 19, 2015

(30) Foreign Application Priority Data
May 20, 2013 (JP) 2013-106090
Jan. 13, 2014 (JP) 2014-003833
Jan. 16, 2014 (JP) 2014-006153
Jan. 27, 2014 (JP) 2014-012670
Feb. 5, 2014 (JP) 2014-019904
Feb. 13, 2014 (JP) 2014-024985
Apr. 17, 2014 (JP) 2014-085414

(51) Int. Cl. H02K 5/10; H02K 11/225

(52) U.S. Cl. CPC H02K 5/10; H02K 11/225

(57) ABSTRACT

Provided are a motor having a small number of parts and provided with waterproof performance in a low-cost method, and a positioning device and a conveyance device that are positioned and driven by the motor. The motor includes a columnar motor body that is formed with a center hole penetrating in an axial direction, and a housing for accommodating the motor body. The housing includes a cylindrical part that covers an outer peripheral surface of the motor body; a rotation output part provided on an upper side of the cylindrical part in the axial direction and fixed to rotary bodies of the motor body; and a fixed part provided on a lower side of the cylindrical part in the axial direction and fixed to fixed bodies of the motor body. The housing is sealed by a sealing mechanism at only one place of the cylindrical part in the axial direction.

### TECHNICAL FIELD

The present disclosure relates to a motor having waterproof performance and dustproof performance, and a positioning device and a conveyance device that are positioned and driven by the motor.

### BACKGROUND ART

In one technology, direct drive motors having high torque and high resolution are capable of directly driving an index table and do not have backlash while having a high-speed operation performance. Therefore, the direct drive motors have been suitably used for applications that demand high-precision positioning.

For example, when an index table having a direct drive motor is used for conveyance in a polishing process or a cleaning process of a semiconductor wafer, a liquid, such as water, may adhere to the semiconductor wafer, or the adhered liquid may fall and stagnate on an upper surface of the direct drive motor. Then, if the liquid enters the direct drive motor, the liquid causes an electrical failure, such as corrosion or short circuiting inside the motor. Hence, the direct drive motor having the performance (waterproof performance) in which entering of a liquid is prevented and the performance (dustproof performance) in which entering of dust is prevented is demanded.

As an example in one technology of the direct drive motor having waterproof performance, a waterproof motor described in PTL 1 is given.

In the waterproof motor, as illustrated in FIG. 25, a motor body is covered with a motor housing 100 having an output shaft (a rotor that outputs rotary power) 160, and a cylindrical part 120. The output shaft 160 is substantially T-shaped, and has a shaft part 161, a disk-like umbrella part 162, a peripheral edge wall 163, and a positioning cylindrical part 164.

The motor housing 100 is formed by integrating the cylindrical part 120 covering an outer peripheral surface of the motor body and a housing base 123. A seal housing 124 is fitted into an opening end of the cylindrical part 120 of the motor housing 100 on the output shaft 160 side via an O ring 113. A space between an inner peripheral surface of the seal housing 124 and the positioning cylindrical part 164 of the output shaft 160 is sealed with an oil seal 191. A space between an upper side of the seal housing 124 and the disk-like umbrella part 162 of the output shaft 160 is sealed with a dust seal 192.

A space between a central opening 123a of the housing base 123 of the motor housing 100 and the shaft part 161 of the output shaft 160 is sealed with an oil seal 193. Additionally, the cylindrical part 120 of the motor housing 100 is formed with a lateral opening 120a, and a waterproof connector 131 is attached to the cylindrical part 120 via a connector spacer 129. A space between the connector spacer 129 and the lateral openings 120a is sealed with packing 128.

A bottom of the housing base 123 is formed with an opening 123b, and the opening 123b is covered with a cover plate 125. Accordingly, a lower part of the housing base 123 is formed with a wiring space 125a.

A motor rotor 141 and a resolver rotor 151 that constitute the motor body are fixed in an axial direction, and are fixed to an outer ring of a rolling bearing 106. The resolver rotor 151 is fixed within the positioning cylindrical part 164 of the output shaft 160. A motor core 142 is fixed to the cylindrical part 210 of the motor housing 100. The resolver stator 152 is fixed to an inner ring of the rolling bearing 6 together with an inner portion 123c of the housing base 123. That is, the motor body of the waterproof motor is of an inner rotor type.

In a portion closer to the center than the positioning cylindrical part 164, the output shaft 160 is fixed to the resolver rotor 151 with a bolt 170. Additionally, the other end of a wiring line having one end connected to the resolver stator 152 is connected to the waterproof connector 131. The wiring line is arranged in a through hole 152a of the resolver stator 152, a through hole 123d of the housing base 123, a wiring space 125a, and an internal space 129a of the connector spacer 129.

PTL 2 describes that a motor having no waterproof performance is used as a waterproof motor by covering the entire motor with a waterproof cover in which an oil seal and a dust seal are assembled to provide a completely sealed structure. An example of the waterproof motor described in PTL 2 also has a substantially T-shaped output shaft similarly to the waterproof motor of PTL 1, and has a double seal structure in which a space between a central opening of a housing base and a shaft part of an output shaft is sealed with an oil seal, and sealing using the oil seal and the dust seal is performed at an outer edge of the output shaft. Further, the housing base and a lower end of the waterproof cover are sealed with the O ring.

### CITATION LIST

### Patent Literature

PTL 1: JP 2011-250504 A

PTL 2: JP 2011-250586 A

### SUMMARY OF INVENTION

### Technical Problem

The waterproof motors described in PTL 1 and PTL 2 have a high cost because the shapes of the substantially T-shaped output shafts are complicated, and plural oil seals and O rings is arranged.

Additionally, in general-purpose waterproof motors, waterproofing of upper and lower surfaces of a columnar motor can be simply handled, for example, by using an O ring during attachment. Further, since a center hole of the motor is used for allowing an air hose or an electrical wiring line to pass therethrough, the entire center hole is normally formed to have a waterproof structure at the time of attachment. Hence, it is only necessary take into consideration the waterproof performance of the outer peripheral surface of a motor in practice. Since the waterproof performance of the waterproof motors described in PTL 1 and PTL 2 can be said to be over-engineered, there is room for improvement in cost reduction.

An object of the present disclosure is to provide a motor having a small number of parts and being arranged with the waterproof performance in a low-cost method, a positioning device, and a conveyance device that are positioned and driven by the motor.

### Solution to Problem

In order to solve the above problem, in one embodiment of the present disclosure, there is provided a motor including a motor body having a column shape in which a center hole penetrating in an axial direction is formed, and a housing for housing the motor body. The housing includes a cylindrical part configured to cover an outer peripheral surface of the motor body; a rotation output part provided on an upper side of the cylindrical part in the axial direction and fixed to rotary body of the motor body; and a fixed part provided on a lower side of the cylindrical part in the axial direction of the cylindrical part and fixed to fixed body of the motor body. The housing is sealed with a sealing mechanism (an oil seal, a V seal, a labyrinth, or the like) at only one place of the cylindrical part in the axial direction of the cylindrical part.

### BRIEF DESCRIPTION OF DRAWINGS

FIG. 1 is a plan view of a motor in first to third, fifth to thirteenth, and fifteenth to twenty-second embodiments of the present disclosure;

FIG. 2 is a sectional view (a sectional view taken along line A-A of FIG. 1) of the motor in the first embodiment of the present disclosure;

FIG. 3 is a bottom plan view of the motor in the first to twenty-second embodiments of the present disclosure, but, an air duct for internal pressure in an eighth embodiment, an eleventh embodiment, a fifteenth embodiment, and an eighteenth embodiment is not illustrated in FIG. 3;

FIG. 4 is a sectional view (a sectional view taken along line A-A of FIG. 1) of the motor in the second embodiment of the present disclosure;

FIG. 5 is a sectional view (a sectional view taken along line A-A of FIG. 1) of the motor in the third embodiment of the present disclosure;

FIG. 6 is a sectional view of the motor in the fourth embodiment of the present disclosure;

FIG. 7 is a sectional view of the motor in the fifth embodiment of the present disclosure;

FIG. 8 is a sectional view of the motor in the sixth embodiment of the present disclosure;

FIG. 9 is a sectional view of the motor in the seventh embodiment of the present disclosure;

FIG. 10 is a sectional view of the motor in the eighth embodiment of the present disclosure;

FIG. 11 is a sectional view of the motor in the ninth embodiment of the present disclosure;

FIG. 12 is a sectional view of the motor in the tenth embodiment of the present disclosure;

FIG. 13 is a sectional view of the motor in the eleventh embodiment of the present disclosure;

FIG. 14 is a sectional view of the motor in the twelfth embodiment of the present disclosure;

FIG. 15 is a sectional view of the motor in the thirteenth embodiment of the present disclosure;

FIG. 16 is a sectional view of the motor in the fourteenth embodiment of the present disclosure;

FIG. 17 is a sectional view of the motor in the fifteenth embodiment of the present disclosure;

FIG. 18 is a sectional view of the motor in the sixteenth embodiment of the present disclosure;

FIG. 19 is a sectional view of the motor in the seventeenth embodiment of the present disclosure;

FIG. 20 is a sectional view of the motor in the eighteenth embodiment of the present disclosure;

FIG. 21 is a sectional view of the motor in the nineteenth embodiment of the present disclosure;

FIG. 22 is a sectional view of the motor in the twentieth embodiment of the present disclosure;

FIG. 23 is a sectional view of the motor in the twenty-first embodiment of the present disclosure;

FIG. 24 is a sectional view of the motor in the twenty-second embodiment of the present disclosure; and

FIG. 25 is a sectional view illustrating a waterproof motor of PTL 1.

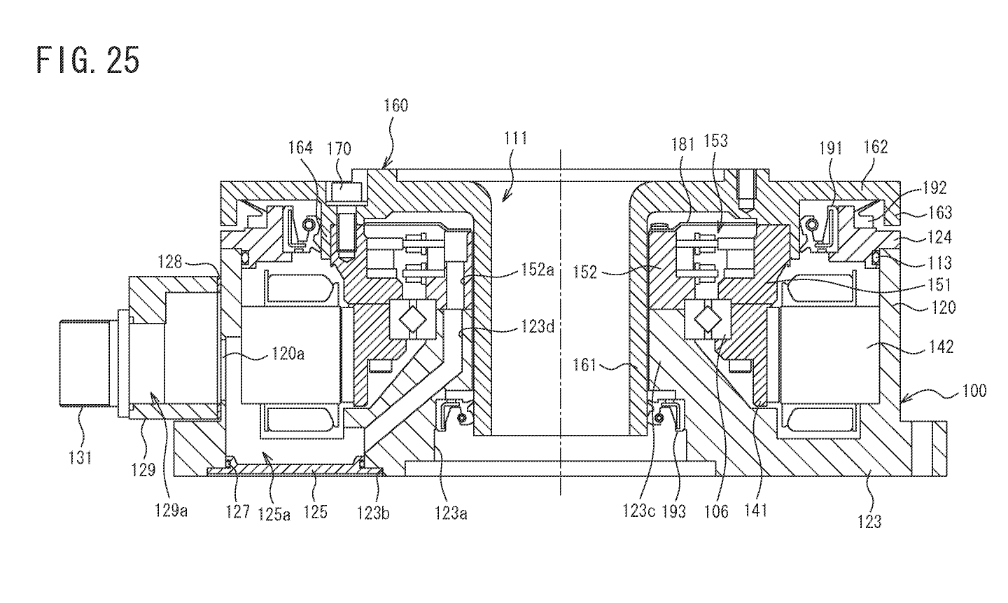

### DESCRIPTION OF EMBODIMENTS

Hereinafter, although embodiments of the present disclosure will be described, the present disclosure is not limited to the embodiments.

### First Embodiment

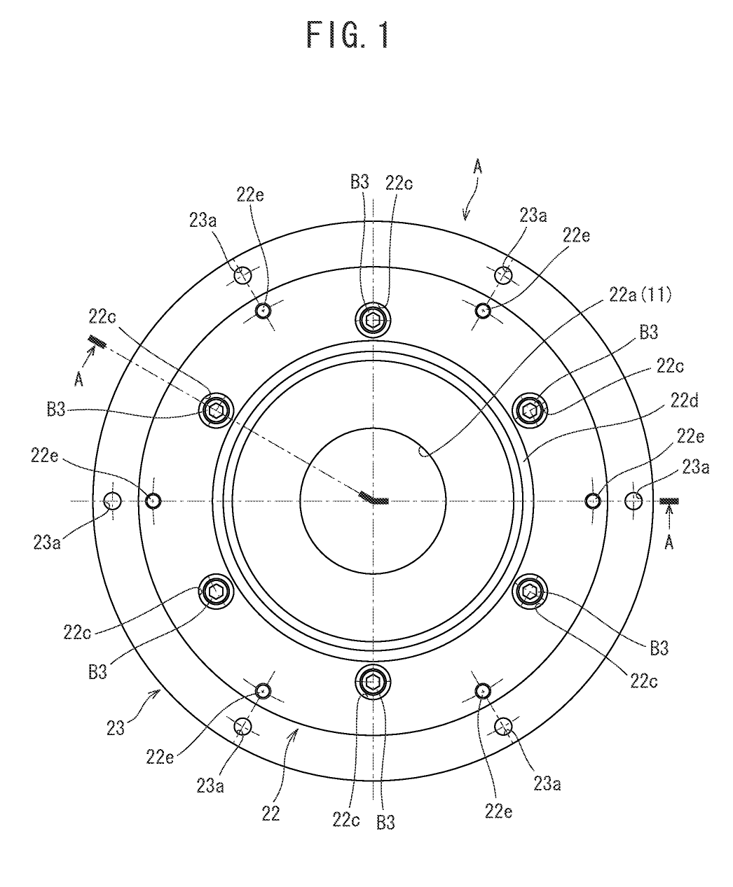

As illustrated in FIGS. 1 to 3, a motor A in the present embodiment includes a motor body 1 having a column shape, a housing 2, and wiring cables 31 and 32. The motor A is a direct drive motor and positions and drives a positioning device (not illustrated).

Here, the motor body 1 has a center hole 11 that penetrates in an axial direction. The motor body 1 has a motor part 4, a resolver (magnetic rotary sensor) 5, and a rolling bearing 6, the motor part 4 is arranged on a lower side in the axial direction, and the resolver 5 is arranged on an upper side in the axial direction. The motor part 4 has a motor stator (stator) 42 arranged therein and a motor rotor (rotor) 41 arranged on an outer peripheral side of the motor stator 42, and becomes an outer rotor type. Additionally, the resolver 5 includes a resolver stator (stator) 52 arranged therein and a resolver rotor (rotor) 51 arranged on an outer peripheral side of the resolver stator 52.

The motor stator 42 has a motor core 42a and a substantially cylindrical inner portion 42b, and the motor core 42a is fixed to an outer periphery of the inner portion 42b. A coil 43 is wound around the motor core 42a.

Meanwhile, the motor rotor 41 is formed in a substantially cylindrical shape, and constitutes a yoke. An inner peripheral surface of the motor rotor 41 is provided with an annular permanent magnet 41a.

The motor rotor 41 and the resolver rotor 51 are fixed to an outer ring of the rolling bearing 6. The inner portion 42b of the motor stator 42 and the resolver stator 52 are fixed to an inner ring of the rolling bearing 6. The motor rotor 41 and the resolver rotor 51 are fixed with a bolt B1. The inner portion 42b of the motor stator 42 and the resolver stator 52 are fixed with a bolt B2.

The motor body 1 further has a motor part cover 7 that covers an axial lower end surface of the motor part 4, and a resolver cover 8 that covers an axial upper end surface of the resolver 5. The motor part cover 7 has a center hole 71 having a slightly larger internal diameter than the external diameter of the inner portion 42b of the motor stator 42. An axial lower end of the inner portion 42b of the motor stator 42 is inserted into the center hole 71 of the motor part cover 7. The resolver cover 8 has a center hole 81 having almost the same diameter as the internal diameter of the resolver stator 52.

The inner portion 42b of the motor stator 42 is formed with a through hole 42c that extends in the axial direction. Cutouts 42d are formed in two places of the axial lower end (the end opposite to the resolver 5) of the inner portion 42b. One of ends of outer shells of the wiring cables 31 and 32 are arranged at the respective cutouts 42d. One end of an internal wiring line of the wiring cable 31 is connected to a rotational position detecting part of the resolver 5 through the through hole 42c of the motor stator 42 and the through hole of the resolver stator 52. A connector 31a is attached to the other end of the wiring cable 31.

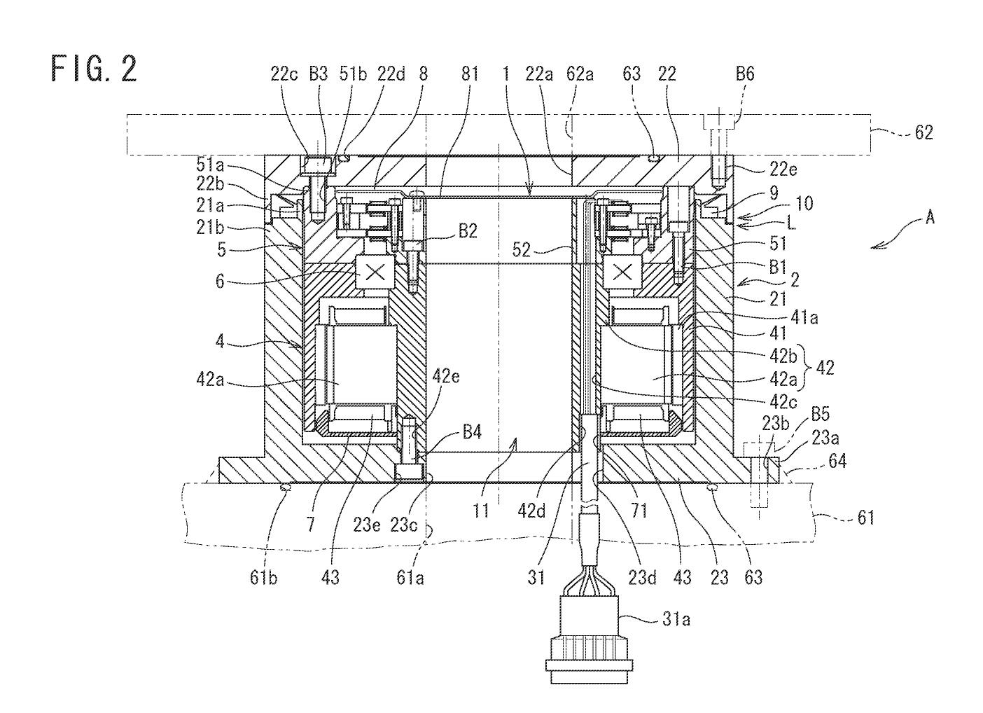

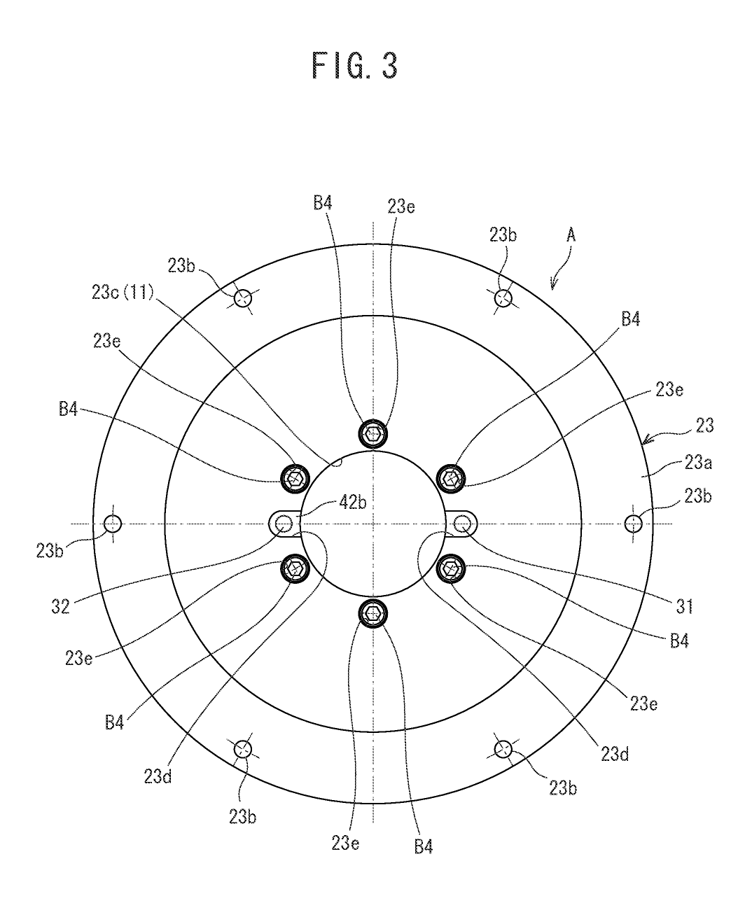

One end of an internal wiring line of the wiring cable 32 is connected to the coil 43 wound around the motor core 42a, and a connector 32a (fourth) is attached to the other end of the wiring cable 32. The connector of the wiring cable 32 is not visible in section A-A (FIG. 2) of FIG. 1. In FIG. 3, the connectors of both the wiring cables 31 and 32 are omitted.

Internal threads 42e are formed in six places of the axial lower end (the end opposite to the resolver 5) of the inner portion 42b where the cutouts 42d are not formed.

An outer edge 51a of the resolver rotor 51 is arranged at an outside of the resolver cover 8. An end surface of the outer edge 51a of the resolver rotor 51 on the motor rotor 41 side is formed with an insertion hole for the bolt B1, and its opposite end surface is formed with internal threads 51b to which bolts B3 are screwed.

The center hole 11 of the motor body 1 is formed with inner peripheral surfaces (center holes) of the motor stator 42 and the resolver stator 52, and a center hole 81 of the resolver cover 8.

The housing 2 includes a cylindrical part 21 that covers an outer peripheral surface of the motor body 1, a rotation output part 22 provided on an axial upper side of the cylindrical part 21 and fixed to a rotor of the motor body 1, and a fixed part 23 provided on an axial lower side of the cylindrical part 21 and fixed to a stator of the motor body 1, and the cylindrical part 21 and the fixed part 23 are formed integrally with each other.

The rotation output part 22 is a disk-like member that has the same external diameter as the external diameter of the cylindrical part 21, and has a center hole (through hole) 22a having the same diameter as the center hole 11 of the motor body 1. An outer edge of the rotation output part 22 is formed with a thin peripheral edge 22b that protrudes to the cylindrical part 21 side. The rotation output part 22 is formed with bolt holes 22c aligned with the internal threads 51b of the resolver rotor 51, and an annular groove 22d is formed closer to an inner side than the bolt holes 22c. An outer edge of the rotation output part 22 is formed with internal threads 22e.

An inner edge of an axial upper end (rotation output part 22 side) of the cylindrical part 21 is formed with a thin peripheral edge 21a that protrudes to the rotation output part 22, and an outer edge thereof is formed with a step 21b that forms a labyrinth L together with the peripheral edge 22b of the rotation output part 22. An oil seal 9 is arranged in a space formed by the peripheral edge 22b of the rotation output part 22 and the peripheral edge 21a of the cylindrical part 21. The oil seal 9 is attached to the cylindrical part 21, and a lip of the oil seal 9 comes into contact with the rotation output part 22. That is, a space between the cylindrical part 21 and the rotation output part 22 is sealed with a sealing mechanism 10 including the oil seal 9 and the labyrinth L.

The fixed part 23 is a disk-like member that has flanges 23a protruding from the external diameter of the cylindrical part 21, and the flanges 23a are formed with bolt insertion holes 23b. The fixed part 23 has a center hole (through hole) 23c having the same diameter as the center hole 11 of the motor body 1. Recesses 23d that are recessed in a U-shape radially outward are formed in two places of the center hole 23c. Due to the presence of the recesses 23d, the wiring cables 31 and 32 pass through the respective recesses 23d without being bent, and extend to the outside of the housing 2.

Bolt insertion holes 23e are formed at positions aligned with the internal threads 42e of the motor stator 42 in the fixed part 23.

The rotation output part 22 is fixed to the resolver rotor (rotor) 51 of the motor body 1 with the bolts B3. The fixed part 23 is fixed to the inner portion 42b of the motor stator (stator) 42 of the motor body 1 with bolts B4.

A member (housing base) into which the cylindrical part 21 and the fixed part 23 are integrated can be obtained by cutting work or a die-casting method of aluminum, and the rotation output part 22 can be obtained similarly. In the surface of the rotation output part 22 with which the lip of the oil seal 9 slides, it is necessary to perform alumite processing or the like, increase hardness, and make surface roughness small.

The motor A can be used, for example, by fixing the fixed part 23 onto a base 61 having a center hole 61a and fixing a table (attached rotating body) 62 having a center hole 62a onto the rotation output part 22, as indicated by two-dot chain lines in FIG. 2. Fixation of the fixed part 23 to the base 61 is performed by screwing bolts B5 that have passed through the bolt insertion holes 23b to the internal threads of the base 61. Fixation of the table 62 to the rotation output part 22 is performed by screwing bolts B6 that have passed through bolt insertion holes of the table 62 to the internal threads 22e of the rotation output part 22.

If such a configuration is adopted, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Further, the motor A in the present embodiment can be used to position and drive the positioning device.

In that case, the waterproof performance between the table 62 and the axial upper side of the motor A can be obtained by arranging an O ring serving as a seal material 63 in the groove 22d of the rotation output part 22. The waterproof performance between the table 62 and the lower side of the motor A can be obtained, for example, by providing an upper surface of the base 61 with an annular groove 61b to arrange the O ring serving as the seal material 63 in the groove 61b or by sealing corners between the flanges 23a of the fixed part 23 and the base 61 with caulking materials (seal material) 64 in a state where the motor A is installed.

Although the center holes 22a and 23c of the housing 2 and the center hole 11 of the motor body 1 communicate with each other, the motor A in the present embodiment does not have a sealing mechanism for these center holes. This is because there is no problem even if only the waterproof performance of the outer peripheral surface of the motor is taken into consideration under normal use as described above. Accordingly, the waterproof motor in the present embodiment has a small number of parts and is low in cost. Additionally, since the number of parts is small, assembling and disassembling are easy and productivity and maintenance performance are high.

Further, in the motor A in the present embodiment, a part consumed due to sliding is only the oil seal 9 attached to one place. Therefore, working hours for maintenance and the cost of replacement parts become low.

Furthermore, the motor A in the present embodiment has not only waterproof performance but also dustproof performance by virtue of the oil seal 9 and the labyrinth L.

Moreover, in the motor A in the present embodiment, the cylindrical part 21 is formed integrally with the fixed part 23. Therefore, there is an effect that inertia can be made smaller than a case where the cylindrical part 21 is formed integrally with the rotation output part 22.

Additionally, by providing an air-purging hole in the fixed part 23, the function of the oil seal 9 can be prevented from declining. That is, the motor A in the present embodiment also has the effect in which an air-purging mechanism can be simply provided.

The motor A in the present embodiment can be obtained by putting the motor body 1, including a non-waterproof motor having a wiring cable to which a non-waterproof connector is attached, into the housing base into which the fixed part 23 and the cylindrical part 21 are integrated, and using the rotation output part 22 as a cover, bringing the lip of the oil seal 9 into contact with the rotation output part 22, and fixing the motor body 1 and the housing 2 with the bolts B3 and B4.

It is to be noted that the housing 2 may be provided with the cylindrical part 21 being formed integrally with the rotation output part 22.

Additionally, the oil seal 9 may be fixed to the rotation output part 22, and the lip of the oil seal 9 may come into contact with the cylindrical part 21.

Further, the oil seal 9 is not installed, and only the labyrinth L can be installed depending on applications.

Furthermore, as the sealing mechanism 10, a sealing mechanism having only one lip may be used like the oil seal 9, or a sealing mechanism having both a dust lip and a seal lip may be used.

### Second Embodiment

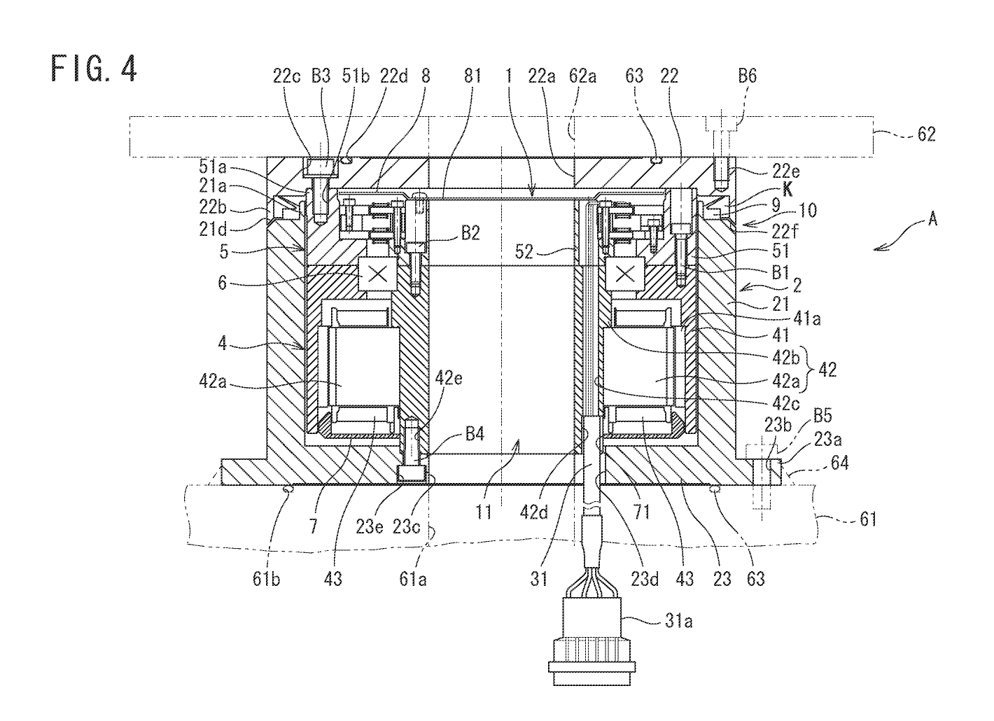

The motor A in the present embodiment is same as that in the first embodiment illustrated in FIG. 2 except that section A-A of FIG. 1 has a shape illustrated in FIG. 4. In FIG. 4, the same members as the members illustrated in FIG. 2 will be designated by the same reference numerals, and the description thereof will be omitted.

That is, in the motor A in the present embodiment, similarly to the first embodiment, the outer edge of the rotation output part 22 is formed with the thin peripheral edge 22b that protrudes to the cylindrical part 21 side. However, an end surface of the thin peripheral edge is a tapered surface 22f that increases in diameter toward the outer peripheral side. A tapered surface 21d that faces the tapered surface 22f with a predetermined gap is formed at an outer edge of one axial end (rotation output part 22 side) of the cylindrical part 21. That is, the space between the cylindrical part 21 and the rotation output part 22 is sealed only with the oil seal 9, which constitutes the sealing mechanism 10. Although an outer peripheral side of the oil seal 9 is enclosed, a sealing mechanism including a labyrinth is not provided.

Hence, according to the motor A in the present embodiment, the effect that a liquid within a space K formed by the peripheral edge 22b of the rotation output part 22, the cylindrical part 21, and the oil seal 9 is discharged with centrifugal force during the rotation of the motor A from a gap between the tapered surface 22f of the peripheral edge 22b and the tapered surface 21d of the cylindrical part 21 is also obtained In addition to the same effects as those of the motor A in the first embodiment. That is, the motor A in the present embodiment has a higher effect than the effect of the motor A in the first embodiment capable of preventing the liquid within the space K from entering the motor body 1.

### Third Embodiment

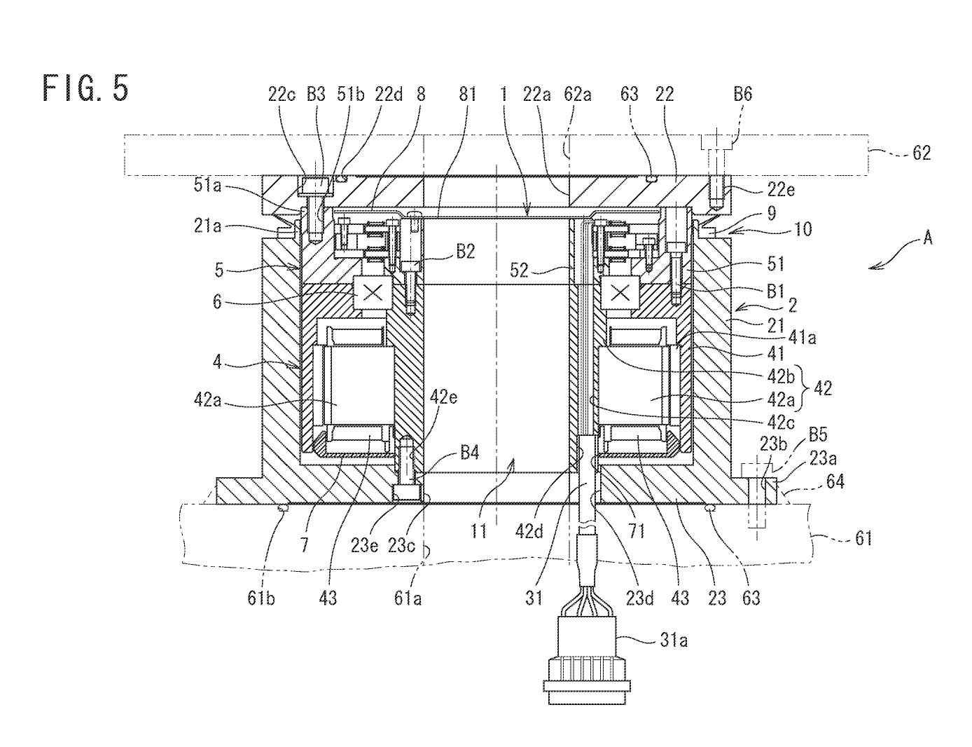

The motor A in the present embodiment is same as that in the first embodiment illustrated in FIG. 2 except that section A-A of FIG. 1 has a shape illustrated in FIG. 5. In FIG. 5, the same members as the members illustrated in FIG. 2 will be designated by the same reference numerals, and the description thereof will be omitted.

That is, in the motor A in the present embodiment, the outer edge of the rotation output part 22 is not formed with the thin peripheral edge 22b that protrudes to the cylindrical part 21 side. Additionally, the outer edge of the axial upper end (rotation output part 22 side) of the cylindrical part 21 is not formed with the step 21b. That is, the space between the cylindrical part 21 and the rotation output part 22 is sealed only with the oil seal 9 so as to constitute the sealing mechanism 10, and the outer peripheral side of the oil seal 9 is open.

Hence, according to the motor A in the present embodiment, the effect that costs can be reduced is also obtained in addition to the same effects as those of the motor A in the first embodiment because the shape of the rotation output part 22 becomes simple by the outer edge of the rotation output part 22 not being formed with the thin peripheral edge 22b.

In addition, in the first to third embodiments, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

### Fourth Embodiment

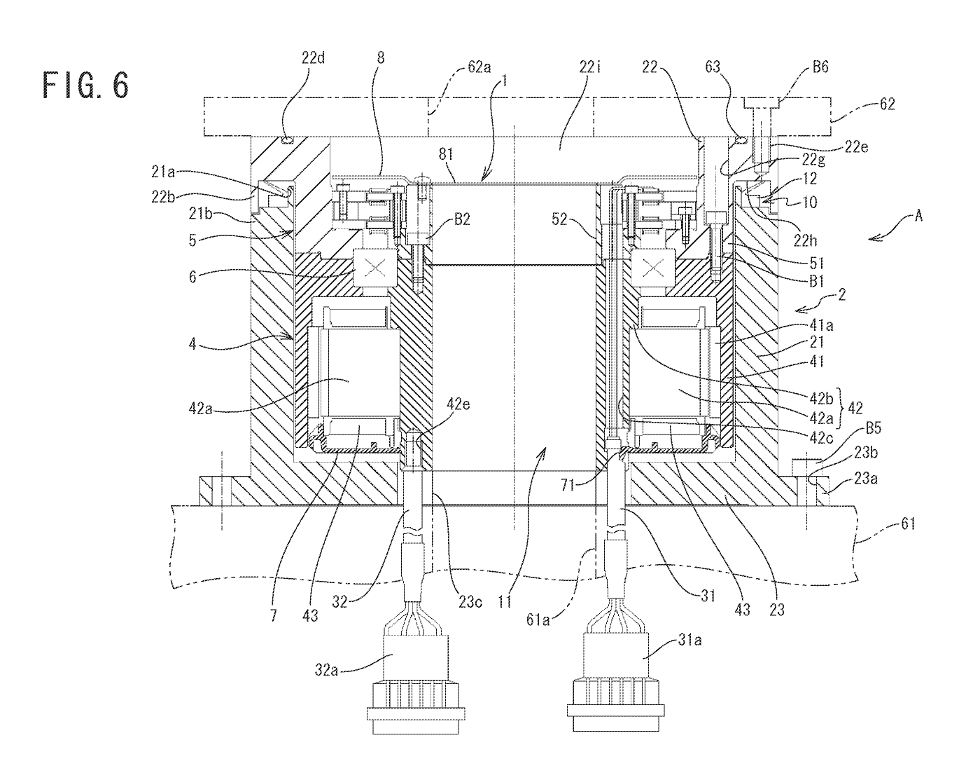

The motor A in the present embodiment is same as that in the first embodiment illustrated in FIG. 2 except that the section thereof has a shape illustrated in FIG. 6. In FIG. 6, the same members as the members illustrated in FIG. 2 will be designated by the same reference numerals, and the description thereof will be omitted.

That is, in the motor A illustrated in FIG. 6, the sealing mechanism 10 that seals the housing 2 in only one axial place of the cylindrical part 21 includes a seal material 12 that is arranged between the cylindrical part 21 and the rotation output part 22 to seal the space between the cylindrical part 21 and the rotation output part 22, and the rotation output part 22 is made of a lightweight material in which the hardness of a seal contact surface 22h coming into contact with the seal material 12 is higher than the hardness of portions other than the seal contact surface 22h.

The seal material 12 is constituted of an oil seal in one embodiment, and is arranged in the space formed by the peripheral edge 22b of the rotation output part 22 and the peripheral edge 21a of the cylindrical part 21. The seal material 12 is attached to the cylindrical part 21, and a lip of the seal material 12 comes into contact with the seal contact surface 22h of the rotation output part 22.

Here, normally, since the seal contact surface 22h in the rotation output part 22 requires substantial hardness, it is necessary to use a steel material as a base material of the rotation output part 22 and perform electroless nickel coating. For this reason, since the entire rotation output part is made of a steel material, the rotation output part is very heavy. In contrast, in the motor A of the present embodiment, the rotation output part 22 is made of a lightweight material in which the hardness of the seal contact surface 22h is made higher than the hardness of portions other than the seal contact surface 22h. For this reason, the weight reduction and low inertia of the rotation output part 22 can be realized while securing the hardness required for the seal contact surface 22h in the rotation output part 22.

At least the seal contact surface 22h of the rotation output part 22 is subjected to hardness-improving treatment, and the hardness-improving treatment is surface treatment. Additionally, the lightweight material of the rotation output part 22 is an aluminum material. In the motor A of the present embodiment, by using the aluminum material, in which the seal contact surface 22h is subjected to hard surface treatment, for the rotation output part 22, the weight reduction and low inertia of the rotation output part 22 can be realized while securing the hardness required for the seal contact surface 22h in the rotation output part 22.

Further, by using the aluminum material with high thermal conductivity for the rotation output part 22, heat dissipation can be improved, and the rated output of the motor A can be improved.

Here, the “aluminum material” refers to a material that mainly includes aluminum, and includes an aluminum alloy. Additionally, anodizing treatment is suitable as the surface treatment.

Furthermore, in this motor A, the above-mentioned hardness-improving treatment may be heat treatment, and the above-mentioned lightweight material may be carbide duralumin.

Moreover, in the motor A, the surface roughness of the seal contact surface 22h of the rotation output part 22 is Ra 0.05 to 1.60, and the fitting between the internal diameter of the seal material 12 and the external diameter of a seal-attached part (the peripheral edge 21a formed in the cylindrical part 21) to which the seal material 12 is attached is an interference fit of 5.0 mm to 25.00 mm.

Additionally, as described in the first embodiment of the motor A, the motor body 1 is of the outer rotor type, the resolver stator 52 is built inside the motor body 1, and the resolver 5 having the resolver rotor 51 is built on the outer peripheral side of the resolver stator 52. In the motor A in the present embodiment, the rotation output part 22 and the resolver rotor 51 are integrated, and the member in which the rotation output part 22 and the resolver rotor 51 are integrated is attached to the motor rotor 41 with bolts B1 via through holes 22g for bolts formed in the portion in which the rotation output part 22 and the resolver rotor 51 are integrated.

Here, since the resolver 5 is a sensor using magnetism, it is necessary to use a nonmagnetic material with little magnetic influence for a peripheral member including the resolver rotor 51 of the resolver 5. Therefore, in a prior art technology, the rotation output part 22 including the peripheral member, including the resolver rotor 51 of the resolver 5, and a steel material could not be integrated. In the motor A of the present embodiment, since the nonmagnetic material of the aluminum material or the carbide duralumin is used for the rotation output part 22, the resolver rotor 51 of the resolver 5 and the rotation output part 22 are integrated. By integrating the resolver rotor 51 of the resolver 5 and the rotation output part 22 using the nonmagnetic material, thermal conductivity becomes high, heat dissipation is improved, and the limitation of the rated output of the motor A caused by heat generation can be relaxed.

In addition, the resolver rotor 51 of the resolver 5 and the rotation output part 22 are integrated, the groove 22d for the seal material 63 provided in a connecting surface of the rotation output part 22 to the table (attached rotating body) 62 is provided closer to the outer peripheral side than the resolver rotor 51, and the rotation output part 22 is provided with an opening 22i that opens from the rotational axis center of the rotation output part 22 to a portion that leads to the vicinity of the resolver rotor 51 inside the groove 22d for the seal material 63.

The diameter of the opening 22i is larger than the diameter of the center hole 11 of the motor A, that is, the diameter of the center hole (through hole) 22a formed in the rotation output part 22 of the motor A in the first embodiment illustrated in FIG. 2. For this reason, the degree of freedom of wiring or piping can be increased more than that in the first embodiment. Additionally, since the opening 22i opens from the rotational axis center of the rotation output part 22 to the portion that leads to the vicinity of the resolver rotor 51 inside the groove 22d for the seal material 63, part replacement and adjustment of the resolver 5 can be easily performed via the opening 22i with a larger diameter.

In addition, the groove 22d for the seal material 63 may be provided in a connecting surface of the table 62 to the rotation output part 22 without being provided in the connecting surface of the rotation output part 22 to the table (attached rotating body) 62. Accordingly, the structure of the rotation output part 22 can be simplified, and the degree of freedom of layout can be made high.

Additionally, since the connectors 31a and 32a are provided in the vicinity of the center hole 11 on the inner peripheral side of the motor body 1, expensive waterproofing specification may not be adopted.

Further, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Additionally, the motor A in the present embodiment can be used to position and drive the positioning device.

Furthermore, in the fourth embodiment, an example of the motor in which the motor body is a direct drive motor (a motor that does not use a speed reducer and directly drives a load) is described. However, the present disclosure can also be applied to motors in which the motor body is a gear reduction type motor (a motor that uses a speed reducer and that amplifies torque), or a general motor (for example, a motor or the like that rotates in only one direction).

Additionally, the motor body 1 may be of an inner rotor type in which an inner peripheral side rotates.

### Fifth Embodiment

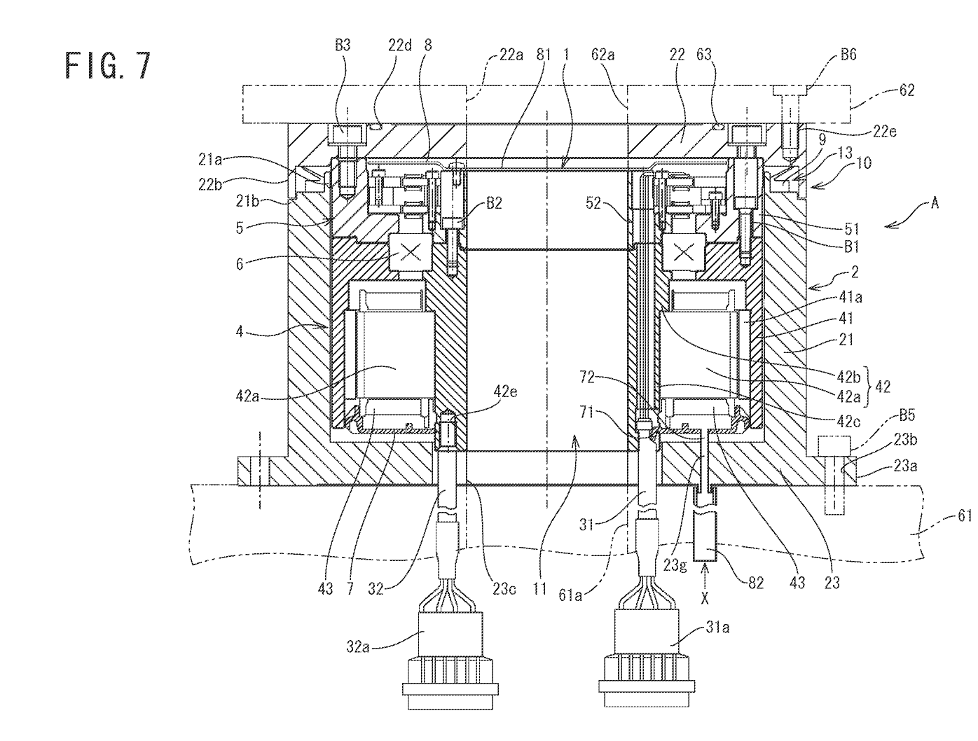

The motor A in the present embodiment is same as that in the first embodiment illustrated in FIG. 2 except that the section thereof has a shape illustrated in FIG. 7. In FIG. 7, the same members as the members illustrated in FIG. 2 will be designated by the same reference numerals, and the description thereof will be omitted.

That is, in the motor A illustrated in FIG. 7, the sealing mechanism 10 that seals the housing 2 in only one axial place of the cylindrical part 21 constitutes liquid entering preventing part 13 that is arranged between the cylindrical part 21 and the rotation output part 22 for preventing a liquid from entering the inside through between the cylindrical part 21 and the rotation output part 22 from the outside.

According to the motor A in the present embodiment, the liquid entering preventing part 13 for preventing a liquid from entering the inside through between the cylindrical part 21 and the rotation output part 22 from the outside is provided in only one axial place of the cylindrical part 21. Therefore, the number of the liquid entering preventing part (seals) that are consumable can be reduced, a low-cost structure can be realized, and maintenance time and effort can also be reduced.

The liquid entering preventing part 13 is constituted of the oil seal 9, and the oil seal 9 is arranged in the space formed by the peripheral edge 22b of the rotation output part 22 and the peripheral edge 21a of the cylindrical part 21. The oil seal 9 is attached to the cylindrical part 21, and the lip of the oil seal 9 comes into contact with the rotation output part 22. Accordingly, the space between the cylindrical part 21 and the rotation output part 22 is sealed with the oil seal 9.

In addition, the liquid entering preventing part 13 may not be the oil seal 9, and may be a dust seal, or a low rotational resistance seal that is used for a bearing seal part.

When the liquid entering preventing part 13 is the oil seal 9, in order to make the hardness of the seal contact surface in the rotation output part 22 high, materials to be used for the rotation output part 22 are limited, or the necessity for performing surface treatment on the seal contact surface occurs. However, when the dust seal or the low rotational resistance seal is used as the liquid entering preventing part 13, surface treatment to be performed on the rotation output part can be freely selected. Additionally, when the dust seal or the low rotational resistance seal is used as the liquid entering preventing part 13, it is possible to provide the motor A in which rotational resistance is low, efficiency is high, and energy is saved. Further, since the output of the motor A can be improved and little heat is generated by friction, the rated output of the motor A can be improved.

Furthermore, in the motor A in the present embodiment, the internal pressure of the motor is increased by air purging. As a specific description, the fixed part 23 of the housing 2 and the motor part cover 7 are provided with an air duct 23g for internal pressure extending from a bottom surface of the fixed part 23 to a through hole 72 of the motor part cover 7. A hose 82 is connected to the outside of the fixed part 23 of the air duct 23g for internal pressure, and air is supplied in the direction of arrow X from the hose 82. Then, the air supplied in the direction of arrow X from the hose 82 enters the motor body 1 through the air duct 23g for internal pressure from the through hole 72 of the motor part cover 7. Accordingly, the internal pressure within the motor body 1 can be increased. Accordingly, the internal pressure also becomes higher than external pressure in the region of the liquid entering preventing part 13, and a liquid can be further prevented from entering from the outside.

Additionally, in the motor A in the present embodiment, a space between the connecting surface of the rotation output part 22 to the table (attached rotating body) 62 and the connecting surface of the table 62 to the rotation output part 22 is sealed. Accordingly, a liquid is prevented from entering the center hole 11 of the motor body 1.

Moreover, in the motor A in the present embodiment, in order to seal the space between the connecting surface of the rotation output part 22 to the table 62 and the connecting surfaces of the table 62 to the rotation output part 22, the connecting surface of the rotation output part 22 to the table 62 is provided with the groove 22d for seal material 63 and the seal material 63 is provided in the groove 22d. Accordingly, a liquid is prevented from entering the center hole 11 of the motor body 1. The groove 22d for the seal material 63 may be provided in the connecting surface of the table 62 to the rotation output part 22.

Further, in the motor A in the present embodiment, the motor body 1 is of the outer rotor type as mentioned above.

Furthermore, since the connectors 31a and 32a are provided in the vicinity of the center hole 11 on the inner peripheral side of the motor body 1, expensive waterproofing specification may not be adopted.

Moreover, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Further, the motor A in the present embodiment can be used to position and drive the positioning device.

Furthermore, in the fifth embodiment, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

### Sixth Embodiment

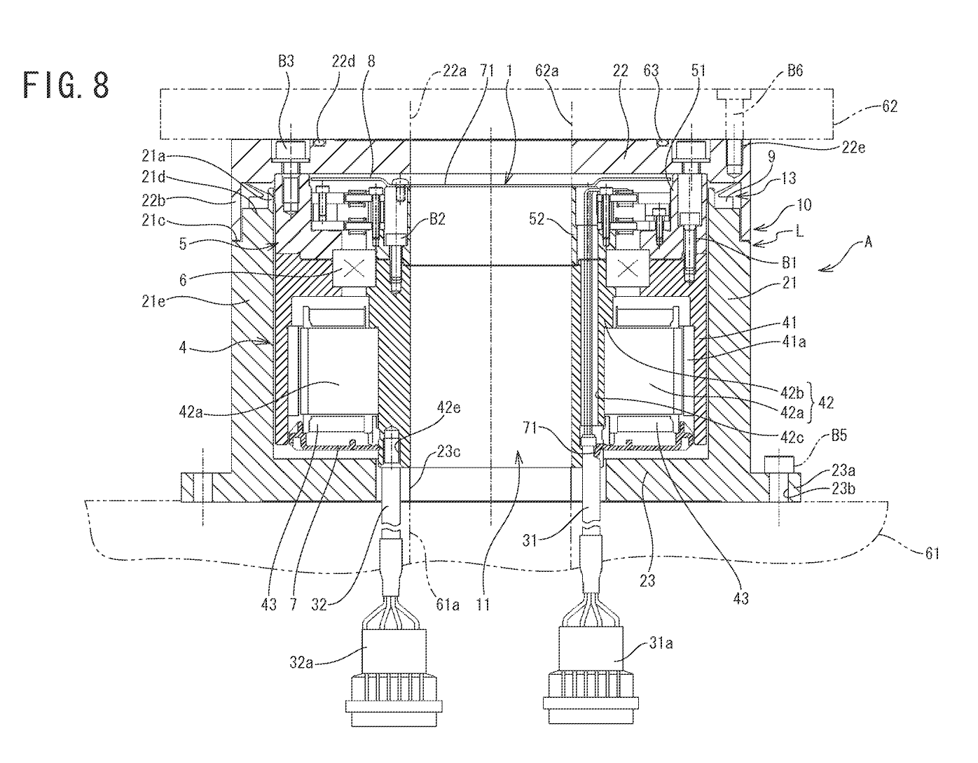

The motor A in the present embodiment is same as that in the fifth embodiment illustrated in FIG. 7 except that the section thereof has a shape illustrated in FIG. 8. In FIG. 8, the same members as the members illustrated in FIG. 7 will be designated by the same reference numerals, and the description thereof will be omitted.

That is, in the motor A illustrated in FIG. 8, the liquid entering preventing part 13 further has the labyrinth L, when compared to the motor A illustrated in FIG. 7. As a specific description, the liquid entering preventing part 13 includes the oil seal 9 and the labyrinth L.

The oil seal 9 is arranged in the space formed by the peripheral edge 22b of the rotation output part 22 and the peripheral edge 21a of the cylindrical part 21. The oil seal 9 is attached to the cylindrical part 21, and the lip of the oil seal 9 comes into contact with the rotation output part 22.

Additionally, an axial upper end of the cylindrical part 21 is formed with a step 21c that changes an external diameter, and the labyrinth L is configured such that a predetermined gap is arranged between an outer peripheral surface of a smaller-diameter portion formed by the step 21c of the cylindrical part 21 and an inner peripheral surface of the peripheral edge 21a of the rotation output part 22, and a predetermined gap is arranged between a surface of the step 21c, which is a boundary between a larger-diameter portion and a smaller-diameter portion of the cylindrical part 21, and a lower end surface of the peripheral edge 22b of the rotation output part 22.

In the motor A in the present embodiment, the liquid entering preventing part 13 constituted of the oil seal 9 and the labyrinth L is capable of preventing a liquid from entering the inside through between the cylindrical part 21 and the rotation output part 22 from the outside.

In addition, similarly to the motor A in the fifth embodiment, not the oil seal 9 but a dust seal, or a low rotational resistance seal that is used for a bearing seal part may be used according to applications.

Additionally, in the motor A in the sixth embodiment, similarly to the motor A in the fifth embodiment, the liquid entering preventing part 13 is provided in only one axial place of the cylindrical part 21. Therefore, the number of the liquid entering preventing part that are consumable can be reduced, a low-cost structure can be realized, and maintenance time and effort can also be reduced.

Further, in the motor A in the sixth embodiment, similarly to the motor A in the fifth embodiment, the internal pressure of the motor may be increased by air purging.

Furthermore, in the motor A in the sixth embodiment, similarly to the motor A in the fifth embodiment, the space between the connecting surface of the rotation output part 22 to the table (attached rotating body) 62 and the connecting surface of the table 62 to the rotation output part 22 is sealed.

Moreover, in the motor A in the sixth embodiment, similarly to the motor A in the fifth embodiment, in order to seal the space between the connecting surface of the rotation output part 22 to the table 62 and the connecting surfaces of the table 62 to the rotation output part 22, the connecting surface of the rotation output part 22 to the table 62 is provided with the groove 22d for the seal material 63 and the seal material 63 is provided in the groove 22d. Accordingly, a liquid is prevented from entering the center hole 11 of the motor body 1. The groove 22d for the seal material 63 may be provided in the connecting surface of the table 62 to the rotation output part 22.

Additionally, in the motor A in the present embodiment, similarly to the fifth embodiment, the motor body 1 is of the outer rotor type.

Further, since the connectors 31a and 32a are provided in the vicinity of the center hole 11 on the inner peripheral side of the motor body 1, expensive waterproofing specification may not be adopted.

Furthermore, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Additionally, the motor A in the present embodiment can be used to position and drive the positioning device.

Moreover, in the sixth embodiment, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

### Seventh Embodiment

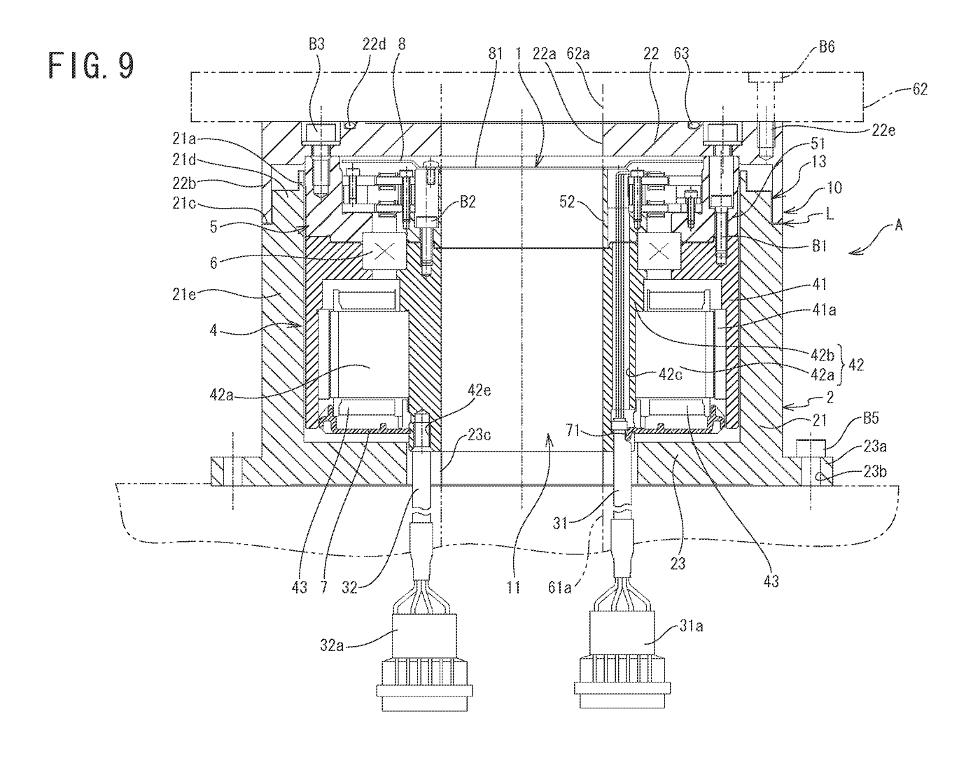

The motor A in the present embodiment is same as that in the sixth embodiment except that the section thereof has a shape illustrated in FIG. 9. In FIG. 9, the same members as the members illustrated in FIG. 8 will be designated by the same reference numerals, and the description thereof will be omitted.

That is, in the motor A illustrated in FIG. 9, the liquid entering preventing part 13 does not have the oil seal 9, and is constituted of the labyrinth L only.

Here, the labyrinth L is configured such that a predetermined gap is arranged between the outer peripheral surface of the smaller-diameter portion formed by the step 21c of the cylindrical part 21 and the inner peripheral surface of the peripheral edge 21a of the rotation output part 22, and a predetermined gap is arranged between the surface of the step 21c, which is the boundary between the larger-diameter portion and the smaller-diameter portion of the cylindrical part 21, and the lower end surface of the peripheral edge 22b of the rotation output part 22.

In the motor A in the present embodiment, the liquid entering preventing part 13 constituted of the labyrinth L can prevent a liquid from entering the inside through between the cylindrical part 21 and the rotation output part 22 from the outside.

It is to be noted that although it is better to combine the labyrinth L with the oil seal 9 as in the sixth embodiment in order to achieve more positive liquid entering prevention, the liquid entering prevention may be sufficient with only the labyrinth L depending on applications. Since the oil seal 9 is not used, not only is manufacturing cost reduced, but also replacement of the oil seal 9 is unnecessary. Thus, maintenance performance is excellent. Additionally, the liquid entering preventing part 13 is brought into a non-contact state. As a result, unlike a case where the oil seal 9 is used, limitations on the hardness and surface roughness of the seal contact surface in the rotation output part 22 can also be avoided, the rotational resistance can be reduced, and motor output can be improved. Additionally, since there is no generation of heat by the friction of the oil seal, the rated output of the motor A can be improved.

In the motor A in the seventh embodiment, similarly to the motor A in the fifth embodiment and the motor A in the sixth embodiment, the liquid entering preventing part 13 is provided in only one axial place of the cylindrical part 21.

Further, in the motor A in the seventh embodiment, similarly to the motor A in the fifth embodiment and the motor A in the sixth embodiment, the internal pressure of the motor may be increased by air purging. In the motor A in the seventh embodiment, the liquid entering preventing part 13 includes the labyrinth L only. Thus, an air purging function is particularly effectively performed against entering liquid.

Furthermore, in the motor A in the seventh embodiment, similarly to the motor A in the fifth embodiment and the motor A in the sixth embodiment, the space between the connecting surface of the rotation output part 22 to the table (attached rotating body) 62 and the connecting surface of the table 62 to the rotation output part 22 is sealed.

Moreover, in the motor A in the seventh embodiment, similarly to the motor A in the fifth embodiment and the motor A in the sixth embodiment, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for seal material 63 and the seal material 63 is provided in the groove 22d. Accordingly, a liquid is prevented from entering the center hole 11 of the motor body 1. The groove 22d for the seal material 63 may be provided in the connecting surface of the table 62 to the rotation output part 22.

Additionally, in the motor A in the seventh embodiment, similarly to the motor A in the fifth embodiment and the motor A in the sixth embodiment, the motor body 1 may be of the outer rotor type.

Further, since the connectors 31a and 32a are provided in the vicinity of the center hole 11 on the inner peripheral side of the motor body 1, expensive waterproofing specification may not be adopted.

Furthermore, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Additionally, the motor A in the present embodiment can be used to position and drive the positioning device.

Further, in the seventh embodiment, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

### Eighth Embodiment

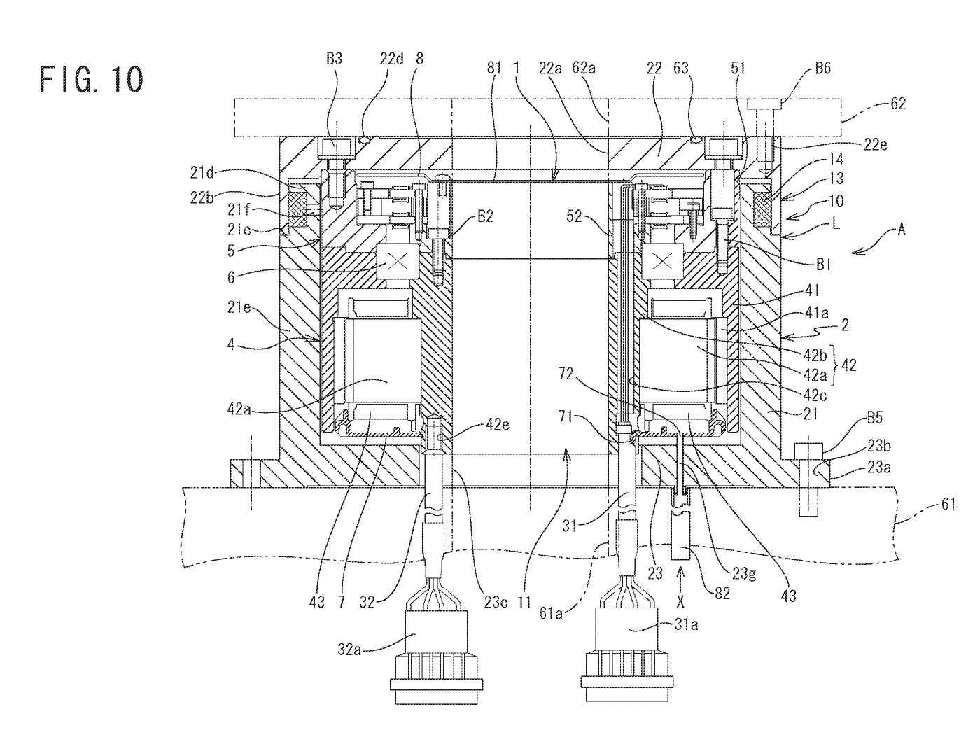

The motor A in the present embodiment is same as that in the seventh embodiment illustrated in FIG. 9 except that the section thereof has a shape illustrated in FIG. 10. In FIG. 10, the same members as the members illustrated in FIG. 9 will be designated by the same reference numerals, and the description thereof will be omitted.

That is, in the motor A illustrated in FIG. 10, the liquid entering preventing part 13 includes a porous member 14 in the vicinity of the labyrinth L.

To describe specifically, the labyrinth L is configured such that a predetermined gap is arranged between the outer peripheral surface of the smaller-diameter portion formed by the step 21c of the cylindrical part 21 and the inner peripheral surface of the peripheral edge 21a of the rotation output part 22, and a predetermined gap is arranged between the surface of the step 21c, which is the boundary between the larger-diameter portion and the smaller-diameter portion of the cylindrical part 21, and the lower end surface of the peripheral edge 22b of the rotation output part 22.

An outer periphery of the smaller-diameter portion of the cylindrical part 21 is formed with an annular recessed groove engraved from the outer periphery, and the annular porous member 14 is arranged within the recessed groove. Although the porous member 14 is annular, the porous member is configured by combining a plurality of members in assembly thereof.

In the motor A in the present embodiment, the porous member 14 is located in the vicinity of the labyrinth L. Thus, if the amount of liquid that has entered the labyrinth L is slight, the liquid can be absorbed due to the capillary phenomenon.

Additionally, the smaller-diameter portion of the cylindrical part 21 is provided with an air duct 21f for a porous member that connects the inside of the motor body 1 and the porous member 14. Accordingly, when air purging is performed (when the internal pressure of the motor is increased by air purging similarly to the motors A in the fifth embodiment to the seventh embodiment in the motor A in the eighth embodiment), homogeneous air is blown off toward the peripheral edge 22b of the rotation output part 22 from the porous member 14, and entering of the liquid from the labyrinth L can be prevented.

In addition, as described in the motor A in the fifth embodiment, the air purging is performed by connecting the hose 82 to the air duct 23g for internal pressure provided in the fixed part 23 of the housing 2 and the motor part cover 7 and supplying air in the direction of arrow X from the hose 82.

In the motor A in the eighth embodiment, the liquid entering preventing part 13 is also brought into a non-contact state. As a result, unlike a case where the oil seal 9 is used, limitations on the hardness and surface roughness of the seal contact surface in the rotation output part 22 can also be avoided, the rotational resistance can be reduced, and motor output can be improved. Additionally, since there is no generation of heat by the friction of the oil seal, the rated output of the motor A can be improved.

In the motor A in the eighth embodiment, similarly to the motors A in the fifth embodiment to the seventh embodiment, the liquid entering preventing part 13 is also provided in only one axial place of the cylindrical part 21.

Further, in the motor A in the eighth embodiment, similarly to the motors A in the fifth embodiment to the seventh embodiment, the space between the connecting surface of the rotation output part 22 to the table (attached rotating body) 62 and the connecting surface of the table 62 to the rotation output part 22 is sealed.

Moreover, in the motor A in the eighth embodiment, similarly to the motors A in the fifth embodiment to the seventh embodiment, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for the seal material 63 and the seal material 63 is provided in the groove 22d. Accordingly, a liquid is prevented from entering the center hole 11 of the motor body 1. The groove 22d for the seal material 63 may be provided in the connecting surface of the table 62 to the rotation output part 22.

Additionally, in the motor A in the eighth embodiment, similarly to the motors A in the fifth embodiment to the seventh embodiment, the motor body 1 is of the outer rotor type.

Further, since the connectors 31a and 32a are provided in the vicinity of the center hole 11 on the inner peripheral side of the motor body 1, expensive waterproofing specification may not be adopted.

Furthermore, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Additionally, the motor A in the present embodiment can be used to position and drive the positioning device.

Moreover, in the eighth embodiment, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

In addition, in the motors A in the fifth to eighth embodiments, the motor body 1 may not be of the outer rotor type, and may be of the inner rotor type in which an inner peripheral side rotates.

### Ninth Embodiment

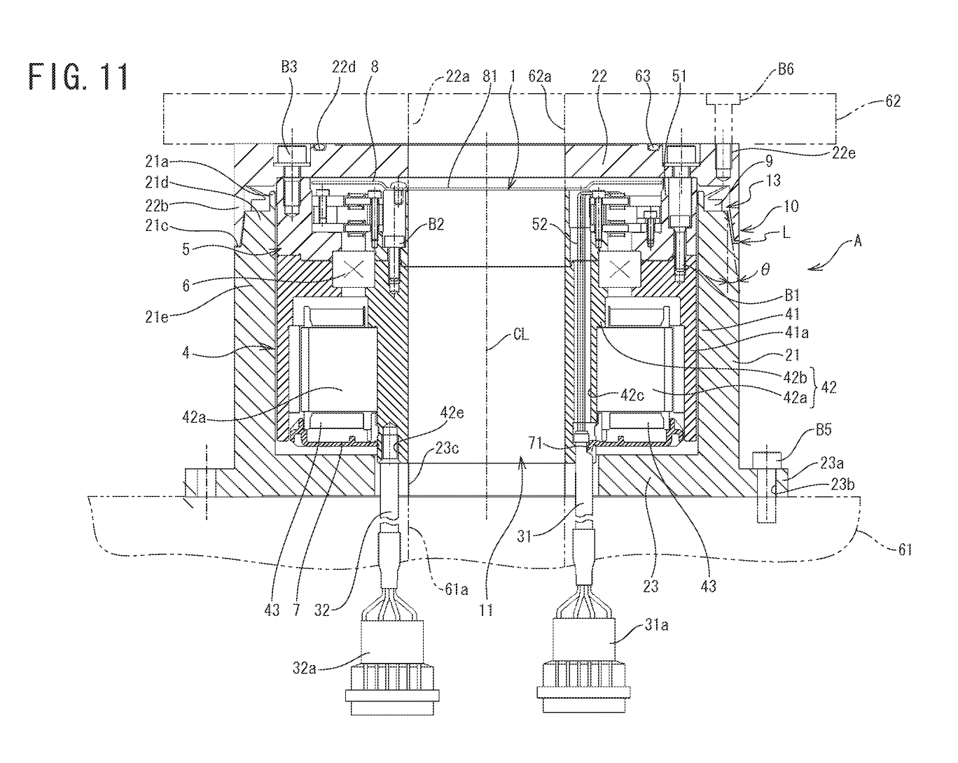

The motor A in the present embodiment is same as that in the fifth embodiment illustrated in FIG. 7 except that the section thereof has a shape illustrated in FIG. 11. In FIG. 11, the same members as the members illustrated in FIG. 7 will be designated by the same reference numerals, and the description thereof will be omitted.

That is, in the motor A illustrated in FIG. 11, similarly to the motor A illustrated in FIG. 7, the sealing mechanism 10 that seals the housing 2 in only one axial place of the cylindrical part 21 constitutes the liquid entering preventing part 13 that is arranged between the cylindrical part 21 and the rotation output part 22 to prevent a liquid from entering the inside through between the cylindrical part 21 and the rotation output part 22 from the outside.

According to the motor A in the present embodiment, similarly to the motor A illustrated in the fifth embodiment, the liquid entering preventing part 13 for preventing a liquid from entering the inside through between the cylindrical part 21 and the rotation output part 22 from the outside is provided in only one axial place of the cylindrical part 21. Therefore, the number of liquid entering preventing part (seals) that are consumable can be reduced, a low-cost structure can be realized, and maintenance time and effort can also be reduced.

The liquid entering preventing part 13 includes the oil seal 9 and the labyrinth L.

Here, the oil seal 9 is arranged in the space formed by the peripheral edge 22b of the rotation output part 22 and the peripheral edge 21a of the cylindrical part 21. The oil seal 9 is attached to the cylindrical part 21, and the lip of the oil seal 9 comes into contact with the rotation output part 22.

Additionally, the axial upper end of the cylindrical part 21 is formed with the step 21c that changes an external diameter, and the labyrinth L is configured such that a predetermined gap is arranged between the outer peripheral surface of the smaller-diameter portion formed by the step 21c of the cylindrical part 21 and the inner peripheral surface of the peripheral edge 21a of the rotation output part 22, and a predetermined gap is arranged between the surface of the step 21c, which is the boundary between the larger-diameter portion and the smaller-diameter portion of the cylindrical part 21, and the lower end surface of the peripheral edge 22b of the rotation output part 22.

In the labyrinth L, the external diameter of the smaller-diameter portion of the cylindrical part 21 and the internal diameter of the peripheral edge 22b of the rotation output part 22 incline at an angle θ with respect to a rotational axis CL of the rotation output part 22 so as to become larger from the axial upper side of the cylindrical part 21 toward the axial lower side thereof.

By forming the labyrinth L in such a tapered shape, the centrifugal force during the rotation of the motor acts on the liquid that has entered the labyrinth L, entering of a liquid can be prevented, and the liquid that has entered can be compulsorily discharged from the labyrinth L.

Further, by forming the labyrinth L in such a tapered shape, it is easy to perform fitting between the cylindrical part 21 of the housing 2 and the peripheral edge 22b of the rotation output part 22 during the assembly of the motor A, and assembling performance and maintenance performance can be improved.

The above-mentioned angle θ of the labyrinth L may be 1° or more and 20° or less, and 5° or more and 15° or less, in one embodiment. When an angle θ is less than 1°, this is not suitable because neither the effect of drainage performance by the centrifugal force nor the effects of improvement in assembling performance and maintenance performance is obtained. Additionally, when an angle θ is larger than 20°, this is not suitable because the influence of the gravity that acts on a liquid becomes smaller, drainage performance falls, the distance of the labyrinth L is not easily secured, and entering of a liquid or foreign matter cannot be prevented.

In addition, similarly to the motor A in the fifth embodiment, not the oil seal 9 but a dust seal, or a low rotational resistance seal that is used for a bearing seal part may be used according to applications.

When the oil seal 9 is used, in order to make the hardness of the seal contact surface in the rotation output part 22 high, materials to be used for the rotation output part 22 are limited, or the necessity for performing surface treatment on the seal contact surface occurs. However, when the dust seal or the low rotational resistance seal is used, surface treatment to be performed on the rotation output part 22 can be freely selected. Additionally, when the dust seal or the low rotational resistance seal is used, it is possible to provide the motor A in which rotational resistance is low, efficiency is high, and energy is saved. Additionally, since the output of the motor A can be improved and little heat is generated by friction, the rated output of the motor A can be improved.

Additionally, in the motor A in the present embodiment, similarly to the motor A in the fifth embodiment illustrated in FIG. 7, the internal pressure of the motor may be increased by air purging.

Further, in the motor A in the present embodiment, similarly to the motor A in the fifth embodiment illustrated in FIG. 7, the space between the connecting surface of the rotation output part 22 to the table (attached rotating body) 62 and the connecting surface of the table 62 to the rotation output part 22 is sealed. Accordingly, a liquid is prevented from entering the center hole 11 of the motor body 1.

Moreover, in the motor A in the present embodiment, similarly to the motor A in the fifth embodiment illustrated in FIG. 7, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for the seal material 63 and the seal material 63 is provided in the groove 22d. Accordingly, a liquid is prevented from entering the center hole 11 of the motor body 1. The groove 22d for the seal material 63 may be provided in the connecting surface of the table 62 to the rotation output part 22.

Additionally, in the motor A in the present embodiment, similarly to the motor A in the fifth embodiment illustrated in FIG. 7, the motor body 1 is of the outer rotor type.

Further, since the connectors 31a and 32a are provided in the vicinity of the center hole 11 on the inner peripheral side of the motor body 1, expensive waterproofing specification may not be adopted.

Furthermore, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Additionally, the motor A in the present embodiment can be used to position and drive the positioning device.

Moreover, in the ninth embodiment, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

### Tenth Embodiment

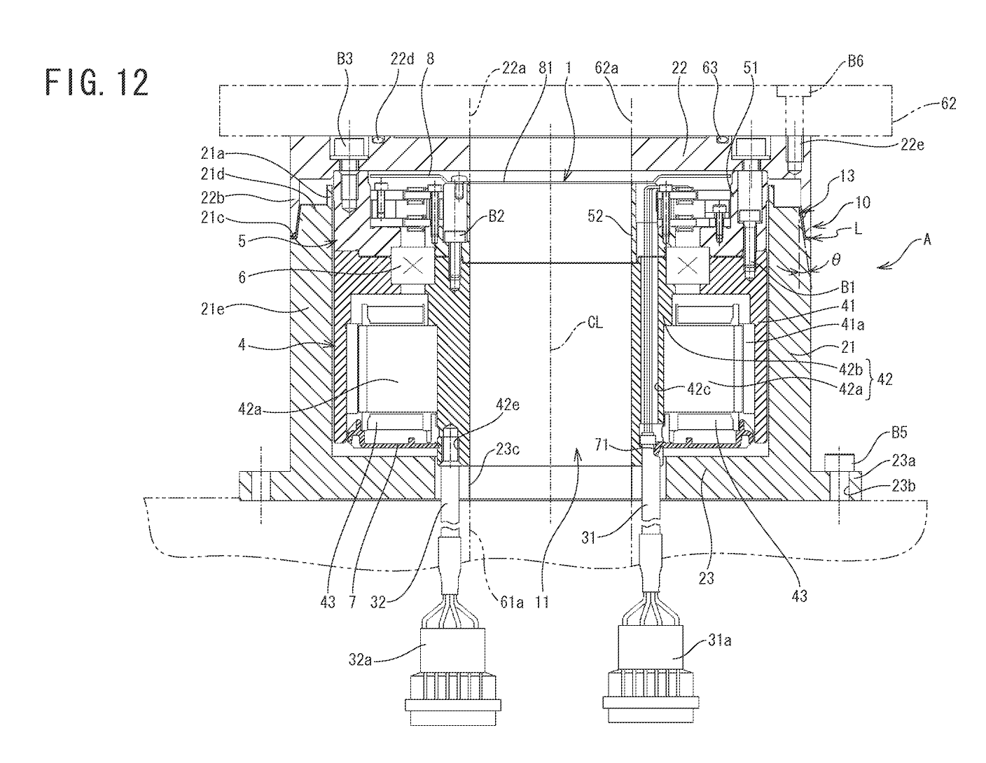

The motor A in the present embodiment is same as that in the ninth embodiment illustrated in FIG. 11 except that the section thereof has a shape illustrated in FIG. 12. In FIG. 12, the same members as the members illustrated in FIG. 11 will be designated by the same reference numerals, and the description thereof will be omitted.

That is, in the motor A illustrated in FIG. 12, the liquid entering preventing part 13 does not have the oil seal 9, and is constituted of the labyrinth L only.

Here, the labyrinth L is configured such that a predetermined gap is arranged between the outer peripheral surface of the smaller-diameter portion formed by the step 21c of the cylindrical part 21 and the inner peripheral surface of the peripheral edge 21a of the rotation output part 22, and a predetermined gap is arranged between the surface of the step 21c, which is the boundary between the larger-diameter portion and the smaller-diameter portion of the cylindrical part 21, and the lower end surface of the peripheral edge 22b of the rotation output part 22. In the labyrinth L, the external diameter of the smaller-diameter portion of the cylindrical part 21 and the internal diameter of the peripheral edge 22b of the rotation output part 22 incline at an angle θ with respect to the rotational axis CL of the rotation output part 22 so as to become larger from the axial upper side of the cylindrical part 21 toward the axial lower side thereof.

In the motor A in the present embodiment, the liquid entering preventing part 13 constituted of the labyrinth L can prevent a liquid from entering the inside through between the cylindrical part 21 and the rotation output part 22 from the outside.

In addition, although it is better to combine the labyrinth L with the oil seal 9 as in the motor A in the ninth embodiment illustrated in FIG. 11 in order to achieve more positive liquid entering prevention, the liquid entering prevention may be sufficient with only the labyrinth L depending on applications. Since the oil seal 9 is not used, not only is manufacturing cost reduced, but also replacement of the oil seal 9 is unnecessary. Thus, maintenance performance is excellent. Additionally, the liquid entering preventing part 13 is brought into a non-contact state. As a result, unlike a case where the oil seal 9 is used, limitations on the hardness and surface roughness of the seal contact surface in the rotation output part 22 can be avoided, the rotational resistance can be reduced, and motor output can be improved. Additionally, since there is no generation of heat by the friction of the oil seal, the rated output of the motor A can be improved.

In the motor A in the tenth embodiment, similarly to the motor A in the ninth embodiment illustrated in FIG. 11, the liquid entering preventing part 13 is also provided in only one axial place of the cylindrical part 21.

Additionally, in the motor A in the tenth embodiment, similarly to the motor A in the ninth embodiment, the internal pressure of the motor may be increased by air purging. In the motor A in the tenth embodiment, the liquid entering preventing part 13 includes the labyrinth L only. Thus, an air purging function is particularly effectively performed against entering liquid.

Further, in the motor A in the tenth embodiment, similarly to the motor A in the ninth embodiment illustrated in FIG. 11, the space between the connecting surface of the rotation output part 22 to the table (attached rotating body) 62 and the connecting surface of the table 62 to the rotation output part 22 is sealed.

Moreover, in the motor A in the tenth embodiment, similarly to the motor A in the ninth embodiment illustrated in FIG. 11, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for the seal material 63 and the seal material 63 is provided in the groove 22d. Accordingly, a liquid is prevented from entering the center hole 11 of the motor body 1. The groove 22d for the seal material 63 may be provided in the connecting surface of the table 62 to the rotation output part 22.

Additionally, in the motor A in the tenth embodiment, similarly to the motor A in the ninth embodiment illustrated in FIG. 11, the motor body 1 is of the outer rotor type.

Further, since the connectors 31a and 32a are provided in the vicinity of the center hole 11 on the inner peripheral side of the motor body 1, expensive waterproofing specification may not be adopted.

Furthermore, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Additionally, the motor A in the present embodiment can be used to position and drive the positioning device.

Moreover, in the tenth embodiment, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

### Eleventh Embodiment

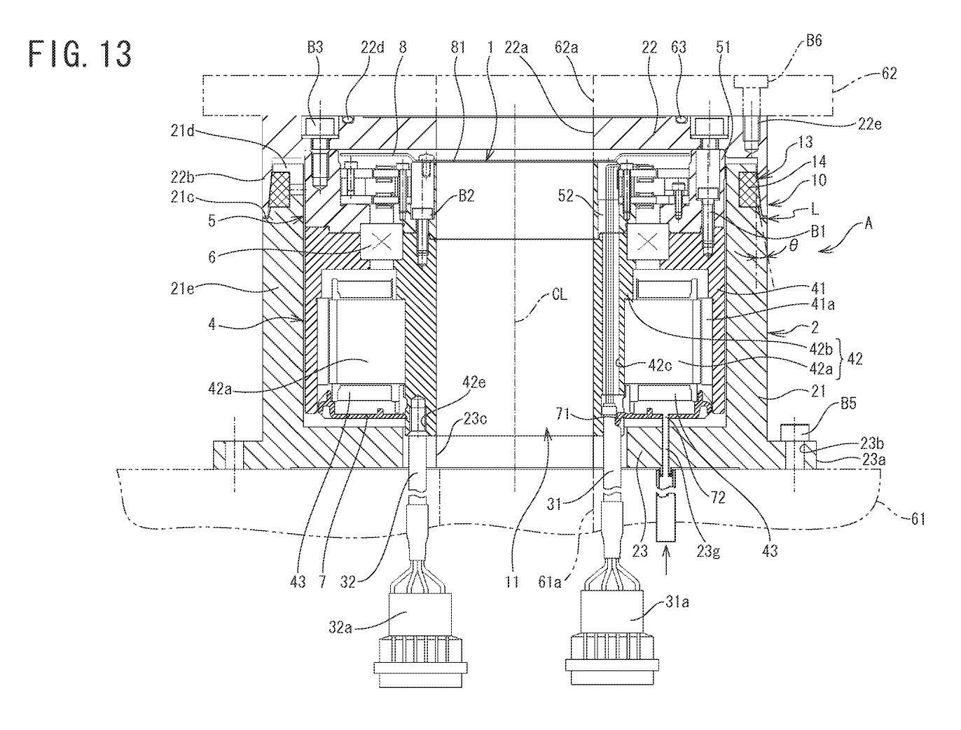

The motor A in the present embodiment is same as that in the tenth embodiment illustrated in FIG. 12 except that the section thereof has a shape illustrated in FIG. 13. In FIG. 13, the same members as the members illustrated in FIG. 12 will be designated by the same reference numerals, and the description thereof will be omitted.

That is, in the motor A illustrated in FIG. 13, the liquid entering preventing part 13 includes a porous member 14 in the vicinity of the labyrinth L.

As a specific description, the labyrinth L is configured such that a predetermined gap is arranged between the outer peripheral surface of the smaller-diameter portion formed by the step 21c of the cylindrical part 21 and the inner peripheral surface of the peripheral edge 21a of the rotation output part 22, and a predetermined gap is arranged between the surface of the step 21c, which is the boundary between the larger-diameter portion and the smaller-diameter portion of the cylindrical part 21, and the lower end surface of the peripheral edge 22b of the rotation output part 22. In the labyrinth L, the external diameter of the smaller-diameter portion of the cylindrical part 21 and the internal diameter of the peripheral edge 22b of the rotation output part 22 incline at an angle θ with respect to the rotational axis CL of the rotation output part 22 so as to become larger from the axial upper side of the cylindrical part 21 toward the axial lower side thereof.

An outer periphery of the smaller-diameter portion of the cylindrical part 21 is formed with an annular recessed groove engraved from the outer periphery, and the annular porous member 14 is arranged within the recessed groove. Although the porous member 14 is annular, the porous member is configured by combining a plurality of members in assembly thereof.

In the motor A in the present embodiment, the porous member 14 is located in the vicinity of the labyrinth L. Thus, if the amount of liquid that has entered the labyrinth L is slight, the liquid can be absorbed due to the capillary phenomenon.

Additionally, the smaller-diameter portion of the cylindrical part 21 is provided with an air duct 21f for a porous member that connects the inside of the motor body 1 and the porous member 14. Accordingly, when air purging is performed, homogeneous air is blown off toward the peripheral edge 22b of the rotation output part 22 from the porous member 14, and entering of the liquid from the labyrinth L can be prevented.

In addition, the air purging is performed by connecting the hose 82 to the air duct 23g for internal pressure provided in the fixed part 23 of the housing 2 and the motor part cover 7 and supplying air in the direction of arrow X from the hose 82.

In the motor A of the eleventh embodiment, similarly to the motor A in the tenth embodiment illustrated in FIG. 12, the liquid entering preventing part 13 is also brought into a non-contact state. As a result, unlike a case where the oil seal 9 is used, limitations on the hardness and surface roughness of the seal contact surface in the rotation output part 22 can be avoided, the rotational resistance can be reduced, and motor output can be improved. Additionally, since there is no generation of heat by the friction of the oil seal, the rated output of the motor A can be improved.

In the motor A in the eleventh embodiment, similarly to the motors A in the ninth embodiment and the tenth embodiment, the liquid entering preventing part 13 is also provided in only one axial place of the cylindrical part 21.

Further, in the motor A in the eleventh embodiment, similarly to the motors A in the ninth embodiment and the tenth embodiment, the space between the connecting surface of the rotation output part 22 to the table (attached rotating body) 62 and the connecting surface of the table 62 to the rotation output part 22 is sealed.

Moreover, in the motor A in the eleventh embodiment, similarly to the motors A in the ninth embodiment and the tenth embodiment, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for the seal material 63 and the seal material 63 is provided in the groove 22d. Accordingly, a liquid is prevented from entering the center hole 11 of the motor body 1. The groove 22d for the seal material 63 may be provided in the connecting surface of the table 62 to the rotation output part 22.

Additionally, in the motor A in the eleventh embodiment, similarly to the motors A in the ninth embodiment to the tenth embodiment, the motor body 1 is of the outer rotor type.

Further, since the connectors 31a and 32a are provided in the vicinity of the center hole 11 on the inner peripheral side of the motor body 1, expensive waterproofing specification may not be adopted.

Furthermore, a conveyance device, which puts electronic components or the like on the table 62 and rotationally moves the electronic components or the like with the motor A in the present embodiment as a driving source, can be used. Additionally, the motor A in the present embodiment can also be used as a driving source of a rotating mechanism of a belt conveyer. Additionally, the motor A in the present embodiment can be used to position and drive the positioning device.

Moreover, in the eleventh embodiment, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

In addition, in the motors A in the ninth to eleventh embodiments, the motor body 1 may not be of the outer rotor type, and may be of the inner rotor type in which an inner peripheral side rotates.

### Twelfth Embodiment

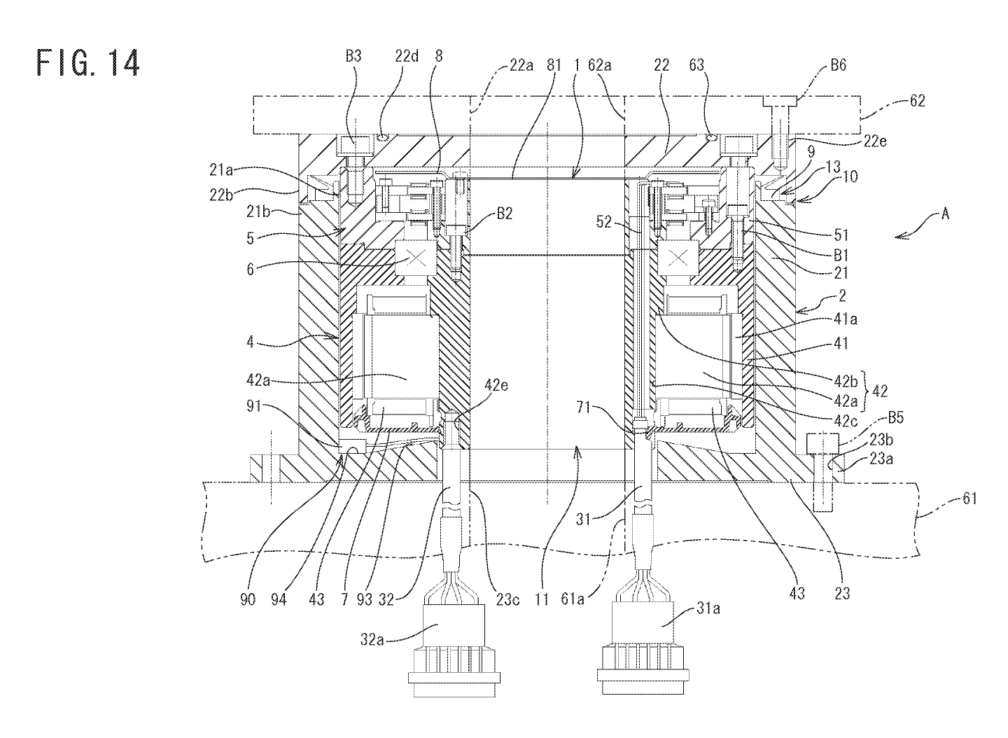

The motor A in the present embodiment is same as that in the first embodiment illustrated in FIG. 2 except that the section thereof has a shape illustrated in FIG. 14. In FIG. 14, the same members as the members illustrated in FIG. 2 will be designated by the same reference numerals, and the description thereof will be omitted.

In the motor A illustrated in FIG. 14, the sealing mechanism 10 that seals the housing 2 in only one axial place of the cylindrical part 21 has the liquid entering preventing part 13 that is arranged between the cylindrical part 21 and the rotation output part 22 to prevent a liquid from entering the inside through between the cylindrical part 21 and the rotation output part 22 from the outside, and further includes a failure preventing part 90 for preventing failure when a liquid enters the inside.

Here, According to the motor A in the present embodiment, the liquid entering preventing part 13 for preventing a liquid from entering the inside through between the cylindrical part 21 and the rotation output part 22 from the outside is provided in only one axial place of the cylindrical part 21. Therefore, the number of the liquid entering preventing part (seals) that are consumable can be reduced, a low-cost structure can be realized, and maintenance time and effort can also be reduced.

The liquid entering preventing part 13 is constituted of the oil seal 9, and the oil seal 9 is arranged in the space formed by the peripheral edge 22b of the rotation output part 22 and the peripheral edge 21a of the cylindrical part 21. The oil seal 9 is attached to the cylindrical part 21, and the lip of the oil seal 9 comes into contact with the rotation output part 22. Accordingly, the space between the cylindrical part 21 and the rotation output part 22 is sealed with the oil seal 9.

Additionally, the failure preventing part 90 is a liquid detecting sensor 91, and is installed in the fixed part 23 of the housing 2 provided on the axial lower side of the cylindrical part 21. The liquid detecting sensor 91 is capable of detecting the liquid that has entered the motor body 1 through between the cylindrical part 21 and the rotation output part 22 from the outside of the housing 2. When a liquid has been detected, the liquid detecting sensor 91 issues an abnormality signal and sends the abnormality signal to abnormality notification part, such as an abnormality lamp (not illustrated) through a cord 92. When the abnormality signal is received, the abnormality notification part notifies a worker of abnormality caused by entering of a liquid with sound, light, or the like. Additionally, the liquid detecting sensor 91 may be connected to a controller (not illustrated) of the motor A, and the motor A may be stopped at a safe position by the controller such that an abnormality signal from the liquid detecting sensor 91 is transmitted to the controller.

The worker can receive notification of abnormality caused by entering of a liquid, and perform suitable treatment, such as replacement of the liquid entering preventing part 13, with respect to entering of the liquid into the motor body 1. In this way, according to the motor A in the twelfth embodiment, a liquid, such as water or oil, can be prevented from stagnating within the motor body 1, and failure of the motor A can be prevented.

The fixed part 23 in which the liquid detecting sensor 91 constituting the failure preventing part 90 is installed has an inclined part 93 that inclines with respect to the axial direction of the cylindrical part 21, and a bottom surface part 94 that horizontally extends from an axial lowermost portion of the inclined part 93, and the liquid detecting sensor 91 is installed on the bottom surface part 94. Accordingly, since the liquid that has entered the motor body 1 is collected due to gravity and gathered in the liquid detecting sensor 91, detection by the liquid detecting sensor 91 becomes possible in an earlier stage, and the possibility of failure of the motor A can be kept low.

In addition, as for the method of the inclination of the inclined part 93, the inclined part just has to incline with respect to the axial direction of the cylindrical part 21. In the motor A illustrated in FIG. 14, in the inclined part 93, an inner peripheral side of the fixed part 23 is located at an upper high position in the axial direction and an outer peripheral side of the fixed part 23 is located at a lower low position in the axial direction. Contrary to this, however, the inner peripheral side of the fixed part 23 may be located at the lower low position in the axial direction, and the outer peripheral side of the fixed part 23 may be located at the upper high position in the axial direction. Additionally, the inclined part 93 may be provided by changing the height thereof in the circumferential direction as well as a case where the height thereof is changed in the radial direction of the fixed part 23. In any case, the bottom surface part 94 is configured so as to horizontally extend from the axial lowermost portion of the inclined part 93, and the liquid detecting sensor 91 is installed on the bottom surface part 94.

### Thirteenth Embodiment

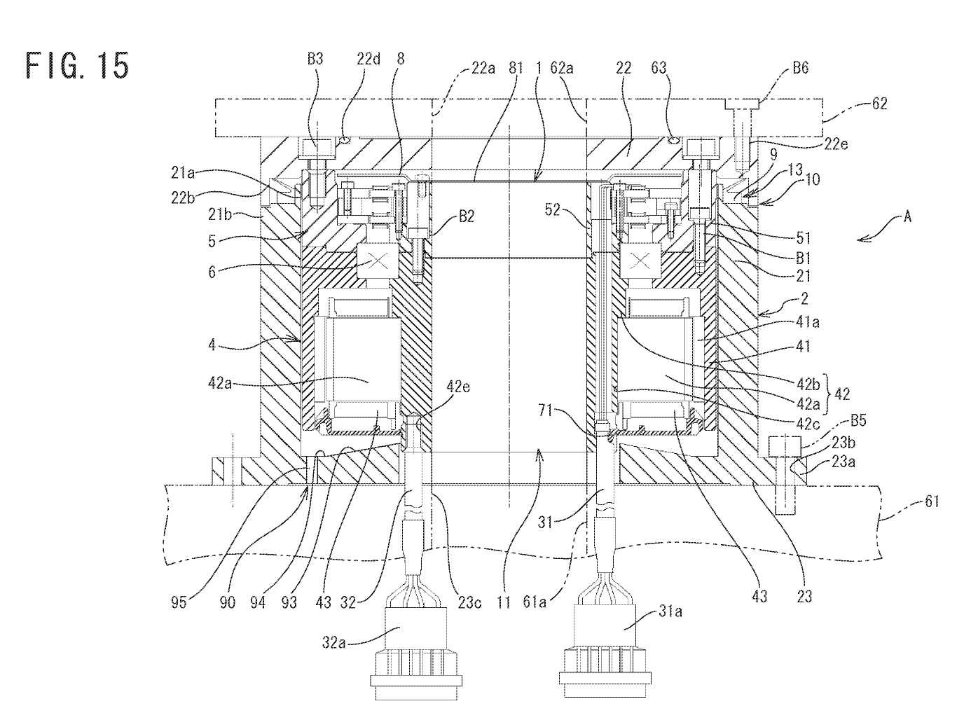

The motor A in the present embodiment is same as that in the twelfth embodiment illustrated in FIG. 14 except that the section thereof has a shape illustrated in FIG. 15. In FIG. 15, the same members as the members illustrated in FIG. 14 will be designated by the same reference numerals, and the description thereof will be omitted.

In the motor A illustrated in FIG. 15, the sealing mechanism 10 that seals the housing 2 in only one axial place of the cylindrical part 21 has the liquid entering preventing part 13 that is arranged between the cylindrical part 21 and the rotation output part 22 to prevent a liquid from entering the inside through between the cylindrical part 21 and the rotation output part 22 from the outside, and further includes failure preventing part 90 for preventing failure when a liquid enters the inside.

Here, According to the motor A in the present embodiment, the liquid entering preventing part 13 for preventing a liquid from entering the inside through between the cylindrical part 21 and the rotation output part 22 from the outside is provided in only one axial place of the cylindrical part 21. Therefore, the number of the liquid entering preventing part (seals) that are consumable can be reduced, a low-cost structure can be realized, and maintenance time and effort can also be reduced.

The liquid entering preventing part 13 is constituted of the oil seal 9, and the oil seal 9 is arranged in the space formed by the peripheral edge 22b of the rotation output part 22 and the peripheral edge 21a of the cylindrical part 21. The oil seal 9 is attached to the cylindrical part 21, and the lip of the oil seal 9 comes into contact with the rotation output part 22. Accordingly, the space between the cylindrical part 21 and the rotation output part 22 is sealed with the oil seal 9.

Additionally, the failure preventing part 90 is a liquid through hole 95 formed in the fixed part 23 of the housing 2 provided on the axial lower side of the cylindrical part 21. The liquid through hole 95 is formed so as to pass through an axial lower surface of the fixed part 23 from an axial upper surface of the fixed part 23. The liquid through hole 95 can allow the liquid, which has entered the motor body 1 through between the cylindrical part 21 and the rotation output part 22 from the outside of the housing 2, to escape to the axial lower side of the housing 2. When a liquid has entered the motor body 1, the liquid flows downward due to gravity, and if the liquid reaches the liquid through hole 95, the liquid is discharged to the lower side of the housing 2 through the liquid through hole 95. If there is no liquid through hole 95, when a liquid enters the motor body 1, the liquid stagnates in the fixed part 23. However, since there is the liquid through hole 95, the liquid is discharged to the lower side of the housing 2 through the liquid through hole 95. Accordingly, the liquid that has entered the motor body 1 can be prevented from stagnating within the housing 2. Additionally, by increasing the internal pressure by virtue of the air purging of sending air into the motor body 1, a liquid more easily escapes from the liquid through hole 95, and the possibility of failure of the motor A can be kept lower.

The fixed part 23 in which the liquid through hole 95 constituting the failure preventing part 90 is formed, similarly to the motor A in the twelfth embodiment illustrated in FIG. 14, has the inclined part 93 that inclines with respect to the axial direction of the cylindrical part 21, and the bottom surface part 94 that horizontally extends from an axial lowermost portion of the inclined part 93. The liquid through hole 95 is formed so as to pass through the bottom surface part 94 upward and downward in the axial direction. Accordingly, since the liquid that has entered the motor body 1 is collected due to gravity and gathered in the liquid through hole 95, liquid escape efficiency obtained by using the liquid through hole 95 rises, the accumulation amount of the liquid can be reduced, and the possibility of failure of the motor A can be kept lower.

In addition, as for the method of the inclination of the inclined part 93, similarly to the twelfth embodiment illustrated in FIG. 14, the inclined part just has to incline with respect to the axial direction of the cylindrical part 21. In the motor A illustrated in FIG. 15, in the inclined part 93, the inner peripheral side of the fixed part 23 is located at the upper high position in the axial direction and an outer peripheral side of the fixed part 23 is located at the lower low position in the axial direction. Contrary to this, however, the inner peripheral side of the fixed part 23 may be located at the lower low position in the axial direction, and the outer peripheral side of the fixed part 23 may be located at the upper high position in the axial direction. Additionally, the inclined part 93 may be provided by changing the height thereof in the circumferential direction as well as a case where the height thereof is changed in the radial direction of the fixed part 23. In any case, the bottom surface part 94 is configured so as to horizontally extend from the axial lowermost portion of the inclined part 93, and the liquid through hole 95 is formed so as to pass through the bottom surface part 94 upward and downward in the axial direction.

In addition, in the motors A in the twelfth embodiment illustrated in FIG. 14 and the thirteenth embodiment illustrated in FIG. 15, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for seal material 63 and the seal material 63 is provided in the groove 22d. Accordingly, a liquid is prevented from entering the center hole 11 of the motor body 1. For this reason, it is not necessary to seal the center hole 11 of the motor body 1 with the liquid entering preventing part 13, and the liquid entering preventing part 13 is arranged in only one axial place on the outer peripheral side of the housing 2.

Additionally, in the motor A in the twelfth embodiment illustrated in FIG. 14 and the thirteenth embodiment illustrated in FIG. 15, one rolling bearing 6 is used. By using the one rolling bearing 6, it is possible to reduce the number of constituent members, simplify structure, facilitate assembly, and by reducing the number of constituent members, the motor A can be made small-sized. As the rolling bearing 6, a four-point-contact ball bearing, a cross roller bearing, or a deep groove ball bearing capable of receiving any load in the axial direction and the radial direction is suitable.

Further, in the motor A in the twelfth embodiment illustrated in FIG. 14, the liquid detecting sensor 91 is used as the failure preventing part 90, and in the motor A in the thirteenth embodiment illustrated in FIG. 15, the liquid through hole 95 is used as the failure preventing part 90. However, the present disclosure is not limited to this, and the failure preventing part 90 may be configured to have the liquid detecting sensor 91 and the liquid through hole 95.

Additionally, in the motor A in the twelfth embodiment illustrated in FIG. 14 and the thirteenth embodiment illustrated in FIG. 15, the rotation output part 22 is fixed to the motor rotor 41 via the resolver rotor 51. By virtue in the present configuration, adjustment of the resolver 5 is made easier.

Further, in the motor A in the twelfth embodiment illustrated in FIG. 14 and the thirteenth embodiment illustrated in FIG. 15, the connectors 31a and 32a may be provided in the vicinity of the center hole 11 on the inner peripheral side of the motor body 1, and expensive waterproofing specification may not be adopted.

Additionally, a conveyance device, which puts electronic components or the like on the table 62 and rotationally moves the electronic components or the like with the motors A in the twelfth embodiment illustrated in FIG. 14 and the thirteenth embodiment illustrated in FIG. 15 as driving sources, can be used. Additionally, the motor A in the present embodiment can also be used as a driving source of a rotating mechanism of a belt conveyer. Additionally, the motor A in the present embodiment can be used to position and drive the positioning device.

Furthermore, in the motors A in the twelfth embodiment illustrated in FIG. 14 and the thirteenth embodiment illustrated in FIG. 15, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

In addition, in the motors A in the twelfth embodiment illustrated in FIG. 14 and the thirteenth embodiment illustrated in FIG. 15, the motor body 1 may not be of the outer rotor type, and may be of the inner rotor type in which an inner peripheral side rotates.

### Fourteenth Embodiment

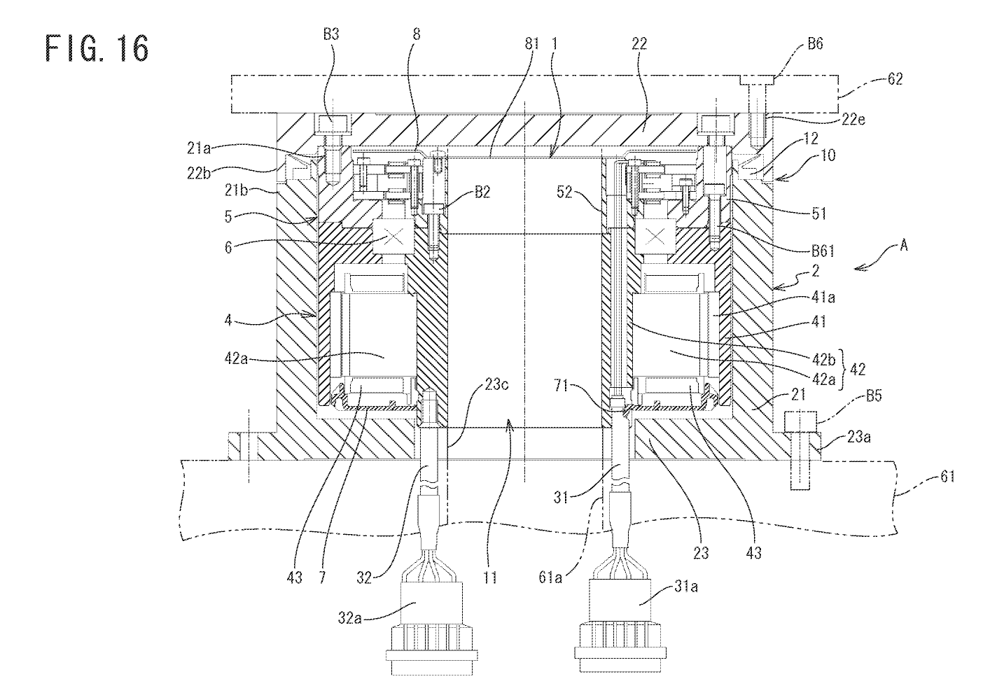

The motor A in the present embodiment is same as that in the first embodiment illustrated in FIG. 2 except that the section thereof has a shape illustrated in FIG. 16. In FIG. 16, the same members as the members illustrated in FIG. 2 will be designated by the same reference numerals, and the description thereof will be omitted.

That is, in the motor A illustrated in FIG. 16, the sealing mechanism 10 that seals the housing 2 in only one axial place of the cylindrical part 21 has the seal material 12 that is arranged between the cylindrical part 21 and the rotation output part 22 to seal the space between the cylindrical part 21 and the rotation output part 22, and the rotation output part 22 is configured so as to cover the center hole 11 of the motor body 1. An oil seal is suitable as the seal material 12.

Usually, in the motor A having the center hole 11 in the motor body 1, the center hole 11 is used to allow wiring lines or pipes to pass therethrough. Therefore, an output side (rotation output part 22 side) also opens, so that wiring lines or pipes can pass from a motor fixed side to the output side. For this reason, the rotation output part 22 also has a center hole penetrating in the axial direction. In the motor A in the fourteenth embodiment illustrated in FIG. 16, waterproof performance is obtained. However, this motor is suitable to a case where the rotation output part 22 is configured so as to cover the center hole 11 of the motor body 1, and wiring or piping that is performed through the center hole 11 of the motor body 1 is unnecessary.

Additionally, in the motor A in the fourteenth embodiment illustrated in FIG. 16, one rolling bearing 6 is used. By using the one rolling bearing 6, it is possible to reduce the number of constituent members, simplify structure, facilitate assembly, and by reducing the number of constituent members, the motor A can be made small-sized. As the rolling bearing 6, a four-point-contact ball bearing, a cross roller bearing, or a deep groove ball bearing capable of receiving any load in the axial direction and the radial direction is suitable.

Additionally, in the motor A in the fourteenth embodiment illustrated in FIG. 16, the rotation output part 22 is fixed to the motor rotor 41 via the resolver rotor 51. By virtue in the present configuration, adjustment of the resolver 5 is made easier.

Further, in the motor A in the fourteenth embodiment illustrated in FIG. 16, the connectors 31a and 32a may be provided in the vicinity of the center hole 11 on the inner peripheral side of the motor body 1, and expensive waterproofing specification may not be adopted.

Furthermore, a conveyance device, which puts electronic components or the like on the table 62 and rotationally moves the electronic components or the like with the motor A in the fourteenth embodiment illustrated in FIG. 16 as a driving source, can be used. Additionally, the motor A in the present embodiment can also be used as a driving source of a rotating mechanism of a belt conveyer. Additionally, the motor A in the present embodiment can be used to position and drive the positioning device.

Moreover, in the motor A in the fourteenth embodiment illustrated in FIG. 16, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

In addition, in the motor A in the fourteenth embodiment illustrated in FIG. 16, the motor body 1 may not be of the outer rotor type, and may be of the inner rotor type in which an inner peripheral side rotates.

### Fifteenth Embodiment

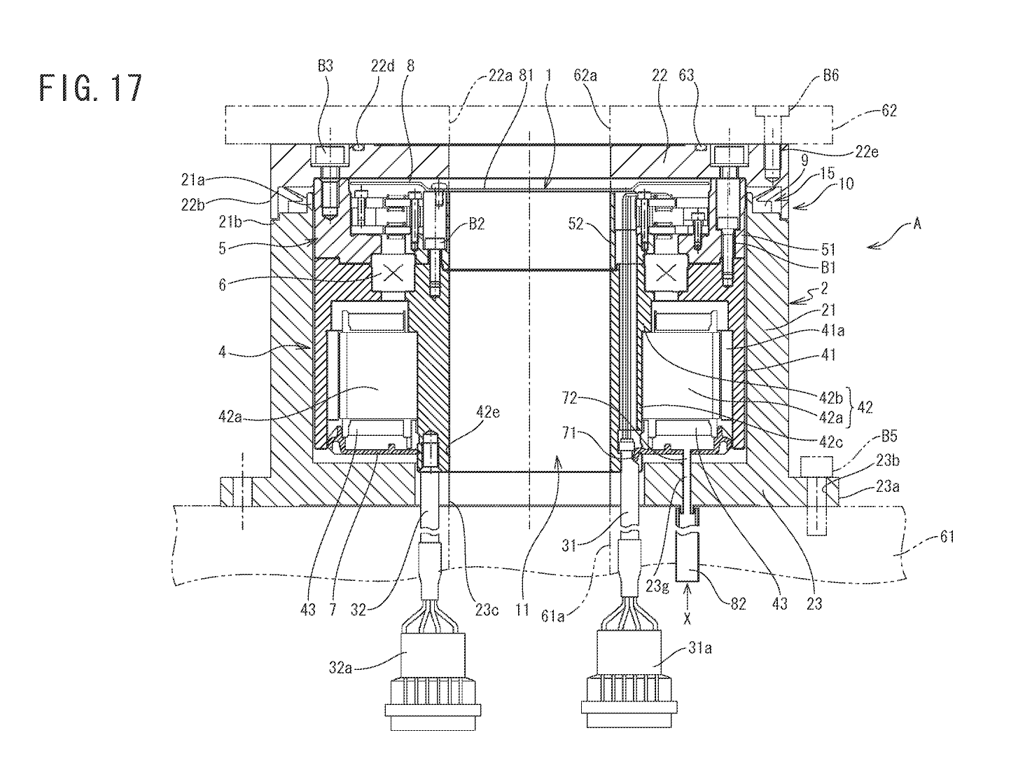

The motor A in the present embodiment is same as that in the fifth embodiment illustrated in FIG. 7 except that the section thereof has a shape illustrated in FIG. 17. In FIG. 17, the same members as the members illustrated in FIG. 7 will be designated by the same reference numerals, and the description thereof will be omitted.

That is, in the motor A in the fifth embodiment illustrated in FIG. 7, the sealing mechanism 10 that seals the housing 2 in only one axial place of the cylindrical part 21 constitutes the liquid entering preventing part 13 that is arranged between the cylindrical part 21 and the rotation output part 22 to prevent a liquid from entering the inside through between the cylindrical part 21 and the rotation output part 22 from the outside. However, in the case of the motor A in the fifteenth embodiment illustrated in FIG. 17, the liquid entering preventing part 13 constitutes a foreign matter entering preventing part 15 for preventing foreign matter from entering the inside through between the cylindrical part 21 and the rotation output part 22 from the outside.

That is, in the motor A in the fifteenth embodiment illustrated in FIG. 17, the sealing mechanism 10 is arranged between the cylindrical part 21 and the rotation output part 22, and constitutes the foreign matter entering preventing part 15 for preventing foreign matter from entering the inside through between the cylindrical part 21 and the rotation output part 22 from the outside.

According to the motor A in the present embodiment, the foreign matter entering preventing part 15 for preventing foreign matter from entering the inside through between the cylindrical part 21 and the rotation output part 22 from the outside is provided in only one axial place of the cylindrical part 21. Therefore, the number of foreign matter entering preventing part (seals) 15 that are consumable can be reduced, a low-cost structure can be realized, and maintenance time and effort can also be reduced. Here, as the “foreign matter”, a liquid, such as water or oil, powder, such as dust or metal powder, or the like is assumed.

The foreign matter entering preventing part 15 is constituted of the oil seal 9, and the oil seal 9 is arranged in the space formed by the peripheral edge 22b of the rotation output part 22 and the peripheral edge 21a of the cylindrical part 21. The oil seal 9 is attached to the cylindrical part 21, and the lip of the oil seal 9 comes into contact with the rotation output part 22. Accordingly, the space between the cylindrical part 21 and the rotation output part 22 is sealed with the oil seal 9.

In addition, the foreign matter entering preventing part 15 may not be the oil seal 9, and may be a dust seal, or a low rotational resistance seal that is used for a bearing seal part.

When the foreign matter entering preventing part 15 is the oil seal 9, in order to make the hardness of the seal contact surface in the rotation output part 22 high, materials to be used for the rotation output part 22 are limited, or the necessity for performing surface treatment on the seal contact surface occurs. However, when the dust seal or the low rotational resistance seal is used as the foreign matter entering preventing part 15, surface treatment to be performed on the rotation output part 22 can be freely selected. Additionally, when the dust seal or the low rotational resistance seal is used as the foreign matter entering preventing part 15, it is possible to provide the motor A in which rotational resistance is low, efficiency is high, and energy is saved. Additionally, since the output of the motor A can be improved and little heat is generated by friction, the rated output of the motor A can be improved.

Additionally, in the motor A in the present embodiment, the internal pressure of the motor is increased by air purging. As a specific description, the fixed part 23 of the housing 2 and the motor part cover 7 are provided with the air duct 23g for internal pressure extending from the bottom surface of the fixed part 23 to a through hole 72 of the motor part cover 7. The hose 82 is connected to the outside of the fixed part 23 of the air duct 23g for internal pressure, and air is supplied in the direction of arrow X from the hose 82. Then, the air supplied in the direction of arrow X from the hose 82 enters the motor body 1 through the air duct 23g for internal pressure from the through hole 72 of the motor part cover 7. Accordingly, the internal pressure within the motor body 1 can be increased. Accordingly, the internal pressure also becomes higher than external pressure in the region of the foreign matter entering preventing part 15, and a liquid can be further prevented from entering from the outside.

Further, in the motor A in the present embodiment, the space between the connecting surface of the rotation output part 22 to the table (attached rotating body) 62 and the connecting surface of the table 62 to the rotation output part 22 is sealed. Accordingly, foreign matter is prevented from entering the center hole 11 of the motor body 1.

Moreover, in the motor A in the present embodiment, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for the seal material 63 and the seal material 63 is provided in the groove 22d. Accordingly, foreign matter is prevented from entering the center hole 11 of the motor body 1. The groove 22d for the seal material 63 may be provided in the connecting surface of the table 62 to the rotation output part 22.

Additionally, in the motor A in the present embodiment, the motor body 1 is of the outer rotor type as mentioned above.

### Sixteenth Embodiment

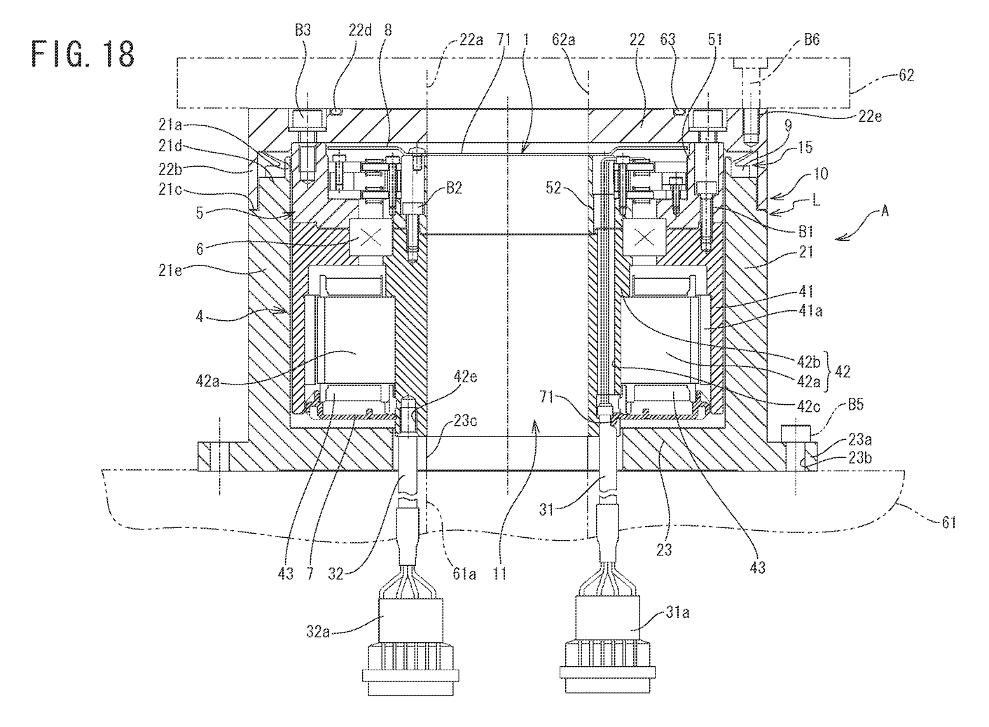

The motor A in the present embodiment is same as that in the fifteenth embodiment illustrated in FIG. 17 except that the section thereof has a shape illustrated in FIG. 18. In FIG. 18, the same members as the members illustrated in FIG. 17 will be designated by the same reference numerals, and the description thereof will be omitted.

That is, in the motor A illustrated in FIG. 18, the foreign matter entering preventing part 15 further has the labyrinth L, when compared to the motor A illustrated in FIG. 17. As a specific description, the foreign matter entering preventing part 15 includes the oil seal 9 and the labyrinth L.

The oil seal 9 is arranged in the space formed by the peripheral edge 22b of the rotation output part 22 and the peripheral edge 21a of the cylindrical part 21. The oil seal 9 is attached to the cylindrical part 21, and the lip of the oil seal 9 comes into contact with the rotation output part 22.

Further, the axial upper end of the cylindrical part 21 is formed with the step 21c that changes an external diameter, and the labyrinth L is configured such that a predetermined gap is arranged between the outer peripheral surface of the smaller-diameter portion formed by the step 21c of the cylindrical part 21 and the inner peripheral surface of the peripheral edge 21a of the rotation output part 22, and a predetermined gap is arranged between the surface of the step 21c, which is the boundary between the larger-diameter portion and the smaller-diameter portion of the cylindrical part 21, and the lower end surface of the peripheral edge 22b of the rotation output part 22.

In the motor A in the present embodiment, the foreign matter entering preventing part 15 constituted of the oil seal 9 and the labyrinth L can prevent foreign matter from entering the inside through between the cylindrical part 21 and the rotation output part 22 from the outside.

In addition, in the motor A in the sixteenth embodiment, similarly to the motor A in the fifteenth embodiment, not the oil seal 9 but a dust seal, or a low rotational resistance seal that is used for a bearing seal part may be used according to applications.

Additionally, in the motor A in the sixteenth embodiment, similarly to the motor A in the fifteenth embodiment, the foreign matter entering preventing part 15 is provided in only one axial place of the cylindrical part 21. Therefore, the number of the foreign matter entering preventing part that are consumable can be reduced, a low-cost structure can be realized, and maintenance time and effort can also be reduced.

Further, in the motor A in the sixteenth embodiment, similarly to the motor A in the fifteenth embodiment, the internal pressure of the motor may be increased by air purging.

Additionally, in the motor A in the sixteenth embodiment, similarly to the motor A in the fifteenth embodiment, the space between the connecting surface of the rotation output part 22 to the table (attached rotating body) 62 and the connecting surface of the table 62 to the rotation output part 22 is sealed.

Moreover, in the motor A in the sixteenth embodiment, similarly to the motor A in the fifteenth embodiment, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for the seal material 63 and the seal material 63 is provided in the groove 22d. Accordingly, foreign matter is prevented from entering the center hole 11 of the motor body 1. The groove 22d for the seal material 63 may be provided in the connecting surface of the table 62 to the rotation output part 22.

Further, in the motor A in the present embodiment, similarly to the fifteenth embodiment, the motor body 1 is of the outer rotor type.

### Seventeenth Embodiment

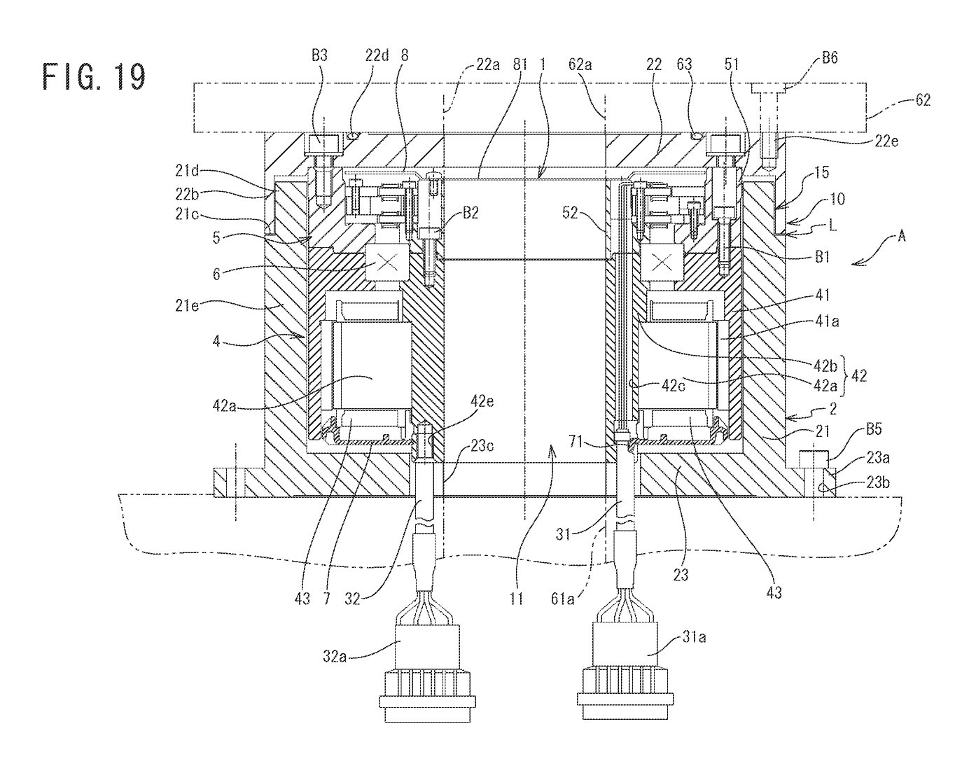

The motor A in the present embodiment is same as that in the sixth embodiment illustrated in FIG. 18 except that the section thereof has a shape illustrated in FIG. 19. In FIG. 19, the same members as the members illustrated in FIG. 18 will be designated by the same reference numerals, and the description thereof will be omitted.

That is, in the motor A illustrated in FIG. 19, the foreign matter entering preventing part 15 does not have the oil seal 9, and is constituted of the labyrinth L only.

Here, the labyrinth L is configured such that a predetermined gap is arranged between the outer peripheral surface of the smaller-diameter portion formed by the step 21c of the cylindrical part 21 and the inner peripheral surface of the peripheral edge 21a of the rotation output part 22, and a predetermined gap is arranged between the surface of the step 21c, which is the boundary between the larger-diameter portion and the smaller-diameter portion of the cylindrical part 21, and the lower end surface of the peripheral edge 22b of the rotation output part 22.

In the motor A in the present embodiment, the foreign matter entering preventing part 15 constituted of the labyrinth L can prevent foreign matter from entering the inside through between the cylindrical part 21 and the rotation output part 22 from the outside.

In addition, although it is better to combine the labyrinth L with the oil seal 9 as in the sixteenth embodiment in order to achieve more positive foreign matter entering prevention, the foreign matter entering prevention may be sufficient with only the labyrinth L depending on applications. Since the oil seal 9 is not used, not only is manufacturing cost reduced, but also replacement of the oil seal 9 is unnecessary. Thus, maintenance performance is excellent. Additionally, the foreign matter entering preventing part 15 is brought into a non-contact state. As a result, unlike a case where the oil seal 9 is used, limitations on the hardness and surface roughness of the seal contact surface in the rotation output part 22 can also be avoided, the rotational resistance can be reduced, and motor output can be improved. Additionally, since there is no generation of heat by the friction of the oil seal, the rated output of the motor A can be improved.

In the motor A in the seventeenth embodiment, similarly to the motor A in the fifteenth embodiment and the motor A in the sixteenth embodiment, the foreign matter entering preventing part 15 is provided in only one axial place of the cylindrical part 21.

Further, in the motor A in the seventeenth embodiment, similarly to the motor A in the fifteenth embodiment and the motor A in the sixteenth embodiment, the internal pressure of the motor may be increased by air purging. In the motor A in the seventeenth embodiment, the foreign matter entering preventing part 15 includes the labyrinth L only. Thus, an air purging function is particularly effectively performed against entering liquid.

Furthermore, in the motor A in the seventeenth embodiment, similarly to the motor A in the fifteenth embodiment and the motor A in the sixteenth embodiment, the space between the connecting surface of the rotation output part 22 to the table (attached rotating body) 62 and the connecting surface of the table 62 to the rotation output part 22 is sealed.

Moreover, in the motor A in the seventeenth embodiment, similarly to the motor A in the fifteenth embodiment and the motor A in the sixteenth embodiment, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for seal material 63 and the seal material 63 is provided in the groove 22d. Accordingly, foreign matter is prevented from entering the center hole 11 of the motor body 1. The groove 22d for the seal material 63 may be provided in the connecting surface of the table 62 to the rotation output part 22.

Additionally, in the motor A in the seventeenth embodiment, similarly to the motor A in the fifteenth embodiment and the motor A in of the sixteenth embodiment, the motor body 1 may be of the outer rotor type.

### Eighteenth Embodiment

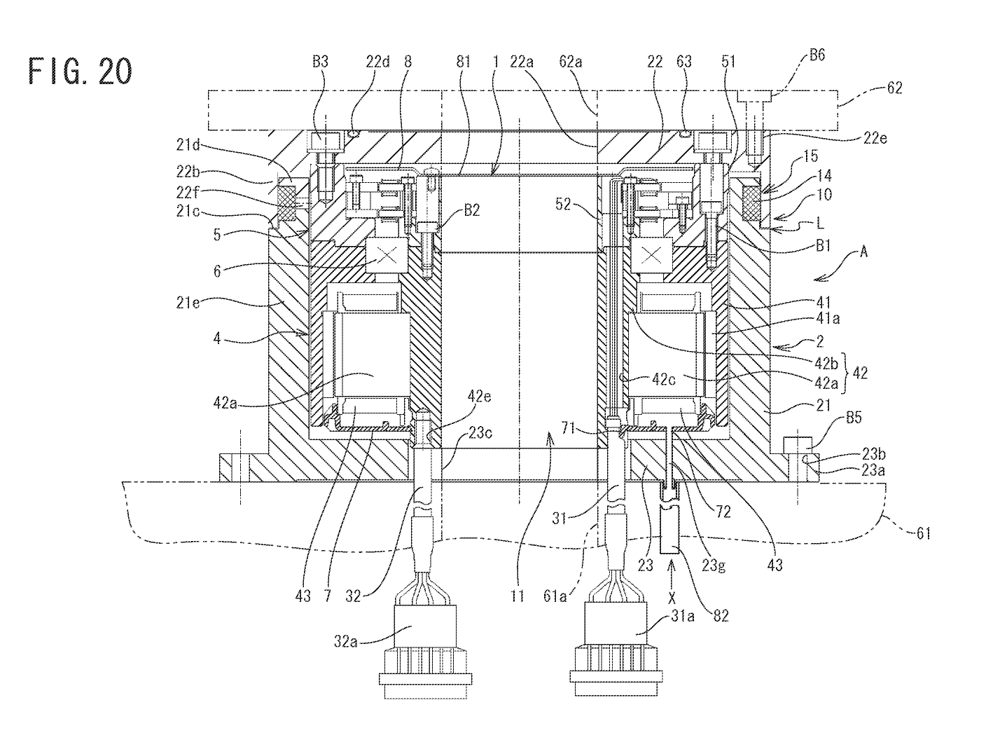

The motor A in the present embodiment is same as that in the seventeenth embodiment illustrated in FIG. 19 except that the section thereof has a shape illustrated in FIG. 20. In FIG. 20, the same members as the members illustrated in FIG. 19 will be designated by the same reference numerals, and the description thereof will be omitted.

That is, in the motor A illustrated in FIG. 20, the foreign matter entering preventing part 15 includes a porous member 14 in the vicinity of the labyrinth L.

As a specific description, the labyrinth L is configured such that a predetermined gap is arranged between the outer peripheral surface of the smaller-diameter portion formed by the step 21c of the cylindrical part 21 and the inner peripheral surface of the peripheral edge 21a of the rotation output part 22, and a predetermined gap is arranged between the surface of the step 21c, which is the boundary between the larger-diameter portion and the smaller-diameter portion of the cylindrical part 21, and the lower end surface of the peripheral edge 22b of the rotation output part 22.

An outer periphery of the smaller-diameter portion of the cylindrical part 21 is formed with an annular recessed groove engraved from the outer periphery, and the annular porous member 14 is arranged within the recessed groove. Although the porous member 14 is annular, the porous member is configured by combining a plurality of members in assembly thereof.

In the motor A in the present embodiment, the porous member 14 is located in the vicinity of the labyrinth L. Thus, if the liquid that has entered the labyrinth L is a slight amount of foreign matter, the liquid can be absorbed due to the capillary phenomenon.

Additionally, the smaller-diameter portion of the cylindrical part 21 is provided with an air duct 21f for a porous member that connects the inside of the motor body 1 and the porous member 14. Accordingly, when air purging is performed (when the internal pressure of the motor is increased by air purging similarly to the motors A in the fifteenth embodiment to the seventeenth embodiment in the motor A in the eighteenth embodiment), homogeneous air is blown off toward the peripheral edge 22b of the rotation output part 22 from the porous member 14, and entering of the foreign matter from the labyrinth L can be prevented.

In addition, as described in the motor A in the fifteenth embodiment, the air purging is performed by connecting the hose 82 to the air duct 23g for internal pressure provided in the fixed part 23 of the housing 2 and the motor part cover 7 and supplying air in the direction of arrow X from the hose 82.

In the motor A in the eighteenth embodiment, the foreign matter entering preventing part 15 is also brought into a non-contact state. As a result, unlike a case where the oil seal 9 is used, limitations on the hardness and surface roughness of the seal contact surface in the rotation output part 22 can be avoided, the rotational resistance can be reduced, and motor output can be improved. Further, since there is no generation of heat by the friction of the oil seal, the rated output of the motor A can be improved.

In the motor A in the eighteenth embodiment, similarly to the motors A in the fifteenth embodiment to the seventeenth embodiment, the foreign matter entering preventing part 15 is also provided in only one axial place of the cylindrical part 21.

Furthermore, in the motor A in the eighteenth embodiment, similarly to the motors A in the fifteenth embodiment to the seventeenth embodiment, the space between the connecting surface of the rotation output part 22 to the table (attached rotating body) 62 and the connecting surface of the table 62 to the rotation output part 22 is sealed.

Moreover, in the motor A in the eighteenth embodiment, similarly to the motors A in the fifteenth embodiment to the seventeenth embodiment, in order to seal the space between the connecting surface of the rotation output part 22 to the table (attached rotating body) 62 and the connecting surfaces of the table 62 to the rotation output part 22, the connecting surface of the rotation output part 22 to the table 62 is provided with the groove 22d for the seal material 63 and the seal material 63 is provided in the groove 22d. Accordingly, a liquid is prevented from entering the center hole 11 of the motor body 1. The groove 22d for the seal material 63 may be provided in the connecting surface of the table 62 to the rotation output part 22.

Additionally, in the motor A in the eighteenth embodiment, similarly to the motors A of the fifteenth embodiment to the seventeenth embodiment, the motor body 1 is of the outer rotor type.

### Nineteenth Embodiment

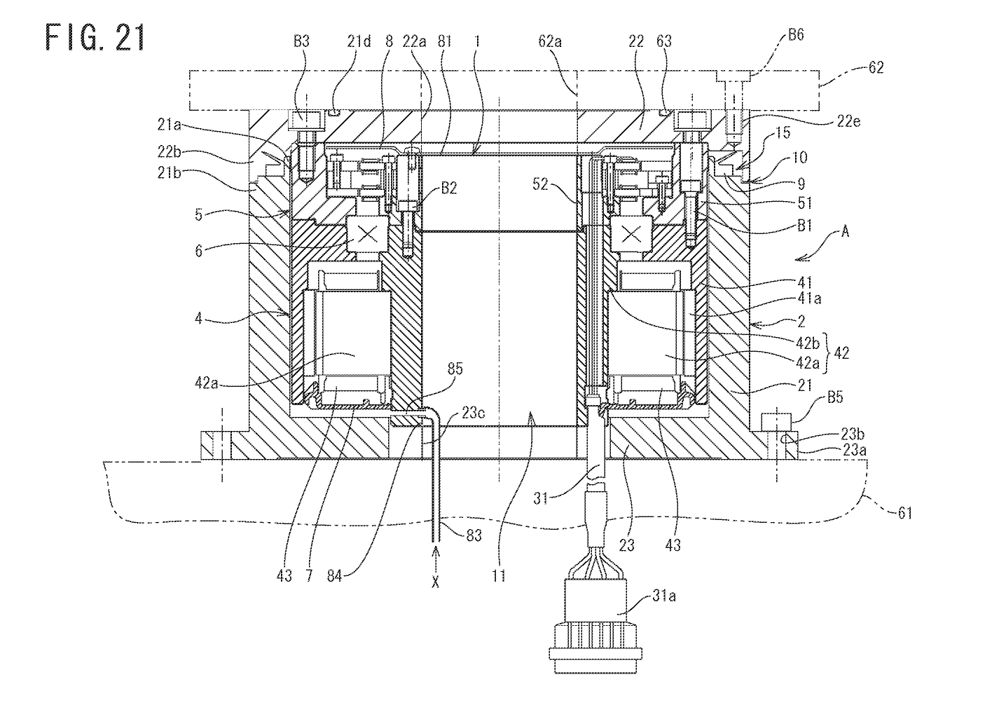

The motor A in the present embodiment is same as that in the fifteenth embodiment illustrated in FIG. 17 except that the section thereof has a shape illustrated in FIG. 21. In FIG. 21, a left half is in a phase with no wiring line that is connected to the connector 32a. In FIG. 21, the same members as the members illustrated in FIG. 17 will be designated by the same reference numerals, and the description thereof will be omitted.

In the motor A in the nineteenth embodiment illustrated in FIG. 21, an air duct 85 for air purging is provided on the inner peripheral side of the motor body 1 with respect to the motor A in the fifteenth embodiment illustrated in FIG. 17.

Here, the air duct 85 is provided in a portion of a peripheral surface of the inner portion 42b of the motor stator 42 that constitutes the motor body 1, and is constituted of a through hole that allows the center hole 11 of the motor body 1 and the inside of the motor body 1 to communicate with each other. An internal thread groove is formed on the center hole 11 side of the air duct 85, and a nipple 84 is screwed to the internal thread groove. A hose 83 is fitted to the nipple 84 through the center hole 11 of the motor body 1, and the air duct 85 and the hose 83 are connected together. The hose 83 is suitable if the hose is fixed using a clamp so as not to slip out of the nipple 84.

By blowing air into the hose 83 in the direction of arrow X, air purging can be performed to increase the internal pressure of the motor body 1. In this way, the piping of the hose 83 is made easier by providing the air duct 85 for air purging on the inner peripheral side of the motor body 1. This is because, in many cases, the center hole 11 is originally provided for wiring or piping and the similar hole for wiring or piping is also provided on the base 61 side where the motor A is installed.

By performing the air purging in this way, the internal pressure of the motor body 1 can be increased, the internal pressure can be made higher than external pressure in the region of the oil seal 9 that constitutes the foreign matter entering preventing part 15, and entering of foreign matter can be further suppressed.

### Twentieth Embodiment

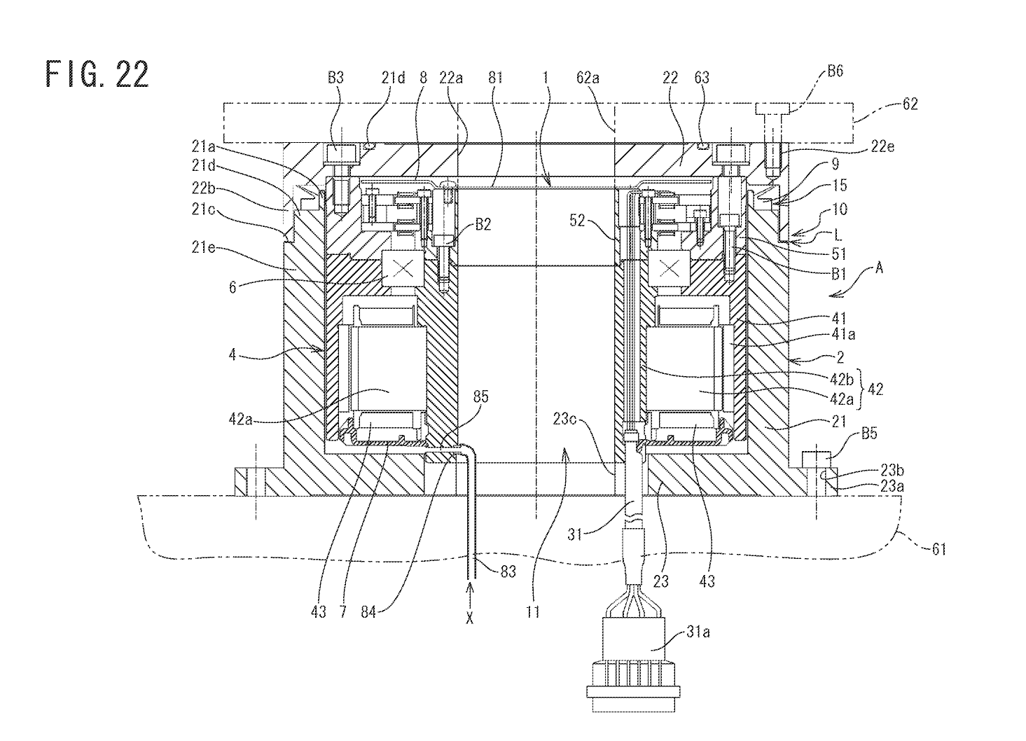

The motor A in the present embodiment is same as that in the sixteenth embodiment illustrated in FIG. 18 except that the section thereof has a shape illustrated in FIG. 22. In FIG. 22, a left half is in a phase with no wiring line that is connected to the connector 32a. In FIG. 22, the same members as the members illustrated in FIG. 18 will be designated by the same reference numerals, and the description thereof will be omitted.

In the motor A in the twentieth embodiment illustrated in FIG. 22, the air duct 85 for air purging is provided on the inner peripheral side of the motor body 1 with respect to the motor A in the sixteenth embodiment illustrated in FIG. 18.

Here, the air duct 85 is provided in a portion of the peripheral surface of the inner portion 42b of the motor stator 42 that constitutes the motor body 1, and is constituted of a through hole that allows the center hole 11 of the motor body 1 and the inside of the motor body 1 to communicate with each other. An internal thread groove is formed on the center hole 11 side of the air duct 85, and the nipple 84 is screwed to the internal thread groove. The hose 83 is fitted to the nipple 84 through the center hole 11 of the motor body 1, and the air duct 85 and the hose 83 are connected together. The hose 83 is suitable if the hose is fixed using a clamp so as not to slip out of the nipple 84.

By blowing air into the hose 83 in the direction of arrow X, air purging can be performed to increase the internal pressure of the motor body 1. In this way, the piping of the hose 83 is made easier by providing the air duct 85 for air purging on the inner peripheral side of the motor body 1. This is because, in many cases, the center hole 11 is originally provided for wiring or piping and the similar hole for wiring or piping is also provided on the base 61 side where the motor A is installed.

By performing the air purging in this way, the internal pressure of the motor body 1 can be increased, the internal pressure can be made higher than external pressure in the region of the oil seal 9 that constitutes the foreign matter entering preventing part 15, and entering of foreign matter can be further suppressed.

### Twenty-First Embodiment

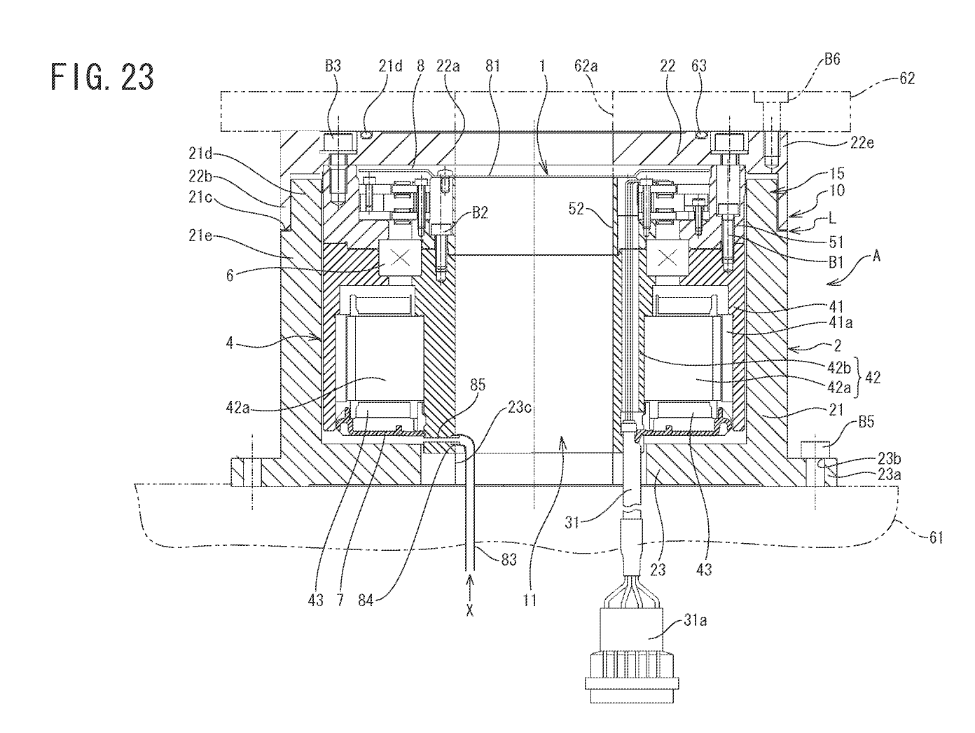

The motor A in the present embodiment is same as that in the seventeenth embodiment illustrated in FIG. 19 except that the section thereof has a shape illustrated in FIG. 23. In FIG. 23, a left half is in a phase with no wiring line that is connected to the connector 32a. In FIG. 23, the same members as the members illustrated in FIG. 19 will be designated by the same reference numerals, and the description thereof will be omitted.

In the motor A in the twenty-first embodiment illustrated in FIG. 23, the air duct 85 for air purging is provided on the inner peripheral side of the motor body 1 with respect to the motor A in the seventeenth embodiment illustrated in FIG. 19.

Here, the air duct 85 is provided in a portion of the peripheral surface of the inner portion 42b of the motor stator 42 that constitutes the motor body 1, and is constituted of a through hole that allows the center hole 11 of the motor body 1 and the inside of the motor body 1 to communicate with each other. An internal thread groove is formed on the center hole 11 side of the air duct 85, and the nipple 84 is screwed to the internal thread groove. The hose 83 is fitted to the nipple 84 through the center hole 11 of the motor body 1, and the air duct 85 and the hose 83 are connected together. The hose 83 is suitable if the hose is fixed using a clamp so as not to slip out of the nipple 84.

By blowing air into the hose 83 in the direction of arrow X, air purging can be performed to increase the internal pressure of the motor body 1. In this way, the piping of the hose 83 is made easier by providing the air duct 85 for air purging on the inner peripheral side of the motor body 1. This is because, in many cases, the center hole 11 is originally provided for wiring or piping and the similar hole for wiring or piping is also provided on the base 61 side where the motor A is installed.

By performing the air purging in this way, the internal pressure of the motor body 1 can be increased, the internal pressure can be made higher than external pressure in the region of the labyrinth L that constitutes the foreign matter entering preventing part 15, and entering of foreign matter can be further suppressed.

### Twenty-Second Embodiment

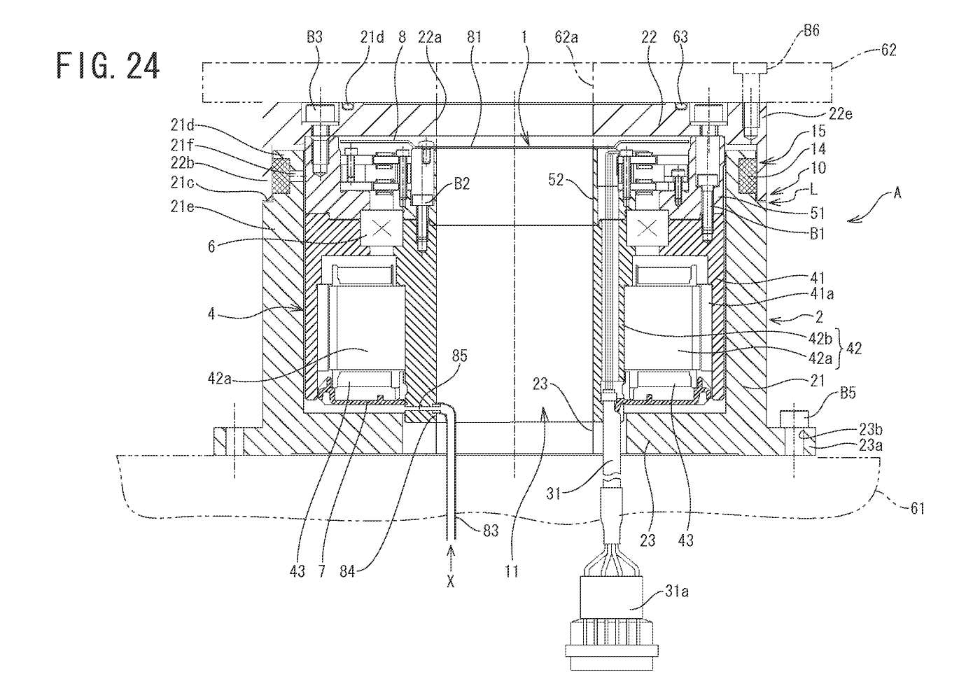

The motor A in the present embodiment is same as that in the eighteenth embodiment illustrated in FIG. 20 except that the section thereof has a shape illustrated in FIG. 24. In FIG. 24, a left half is in a phase with no wiring line that is connected to the connector 32a. In FIG. 24, the same members as the members illustrated in FIG. 20 will be designated by the same reference numerals, and the description thereof will be omitted.

In the motor A in the twenty-second embodiment illustrated in FIG. 24, the air duct 85 for air purging is provided on the inner peripheral side of the motor body 1 with respect to the motor A in the eighteenth embodiment illustrated in FIG. 20.

Here, the air duct 85 is provided in a portion of the peripheral surface of the inner portion 42b of the motor stator 42 that constitutes the motor body 1, and is constituted of a through hole that allows the center hole 11 of the motor body 1 and the inside of the motor body 1 to communicate with each other. An internal thread groove is formed on the center hole 11 side of the air duct 85, and the nipple 84 is screwed to the internal thread groove. The hose 83 is fitted to the nipple 84 through the center hole 11 of the motor body 1, and the air duct 85 and the hose 83 are connected together. The hose 83 is suitable if the hose is fixed using a clamp so as not to slip out of the nipple 84.

By blowing air into the hose 83 in the direction of arrow X, air purging can be performed to increase the internal pressure of the motor body 1. In this way, the piping of the hose 83 is made easier by providing the air duct 85 for air purging on the inner peripheral side of the motor body 1. This is because, in many cases, the center hole 11 is originally provided for wiring or piping and the similar hole for wiring or piping is also provided on the base 61 side where the motor A is installed.

By performing the air purging in this way, the internal pressure of the motor body 1 can be increased, the internal pressure can be made higher than external pressure in the region of the labyrinth L and the porous member 14 that constitutes the foreign matter entering preventing part 15, and entering of foreign matter can be further suppressed.

Additionally, in the motor A in the fifteenth embodiment illustrated in FIG. 17 to the motor A in the twenty-second embodiment illustrated in FIG. 24, the rotation output part 22 is fixed to the motor rotor 41 via the resolver rotor 51. By virtue in the present configuration, adjustment of the resolver 5 is made easier.

Further, in the motor A in the fifteenth embodiment illustrated in FIG. 17 to the motor A in the twenty-second embodiment illustrated in FIG. 24, the connectors 31a and 32a may be provided in the vicinity of the center hole 11 on the inner peripheral side of the motor body 1, and expensive waterproofing specification may not be adopted.

Furthermore, a conveyance device, which puts electronic components or the like on the table 62 and rotationally moves the electronic components or the like with the motor A in the fifteenth embodiment illustrated in FIG. 17 to the motor A in the twenty-second embodiment illustrated in FIG. 24 as driving sources, can be used. Additionally, the motor A in the present embodiment can also be used as a driving source of a rotating mechanism of a belt conveyer. Additionally, the motor A in the present embodiment can be used to position and drive the positioning device.

Moreover, in the motor A in the fifteenth embodiment illustrated in FIG. 17 to the motor A in the twenty-second embodiment illustrated in FIG. 24, an example of the motor in which the motor body is a direct drive motor (a motor that does not use a speed reducer and directly drives a load) is described. However, the present disclosure is also applicable to motors in which the motor body is a gear reduction type motor (a motor that uses a speed reducer and that amplifies torque), or a general motor (for example, a motor or the like that rotates in only one direction).

In addition, in the motor A in the fifteenth embodiment illustrated in FIG. 17 to the motor A in the twenty-second embodiment illustrated in FIG. 24, the motor body 1 may not be of the outer rotor type, and may be of the inner rotor type in which an inner peripheral side rotates.

In order to solve the above problem, in one embodiment of the present disclosure, there is provided a motor including a motor body having a column shape in which a center hole penetrating in an axial direction is formed, and a housing for housing the motor body. The housing includes a cylindrical part configured to cover an outer peripheral surface of the motor body; a rotation output part provided on an upper side of the cylindrical part in the axial direction and fixed to rotary body of the motor body; and a fixed part provided on a lower side of the cylindrical part in the axial direction of the cylindrical part and fixed to fixed body of the motor body. The housing is sealed with a sealing mechanism (an oil seal, a V seal, a labyrinth, or the like) at only one place of the cylindrical part in the axial direction of the cylindrical part.

The above-described motor has a small number of parts and is endowed with waterproof performance by a low-cost method, as compared to the waterproof motors described in PTL 1 and PTL 2, because the housing is sealed by the sealing mechanism in only one axial place of the cylindrical part. Additionally, since normal sealing mechanisms have not only the waterproof performance but also the dustproof performance, the above-described motor also has dustproof performance (performance in which entering of dust is prevented).

Further, in the above-described motor, the sealing mechanism may be arranged between the cylindrical part and the rotation output part to seal a space between the cylindrical part and the rotation output part.

Additionally, in the above-described motor, the housing may be configured to have a through hole corresponding to the center hole of the motor body, and to include a wiring cable having one end fixed to the motor body, and the wiring cable is configured to have the other end arranged at an outside (outside of the motor) by passing through a vicinity of the center hole, of an axial end surface of the motor body and the through hole of the housing.

Furthermore, in the above-described motor, the cylindrical part may be formed integrally with either the fixed part or the rotation output part.

In this case, (a) a configuration in which the cylindrical part is formed integrally with the fixed part, (b) a configuration in which the cylindrical part is formed integrally with the rotation output part, and (c) a configuration in which the cylindrical part is formed integrally with both the fixed part and the rotation output part are included.

In the case of the configuration (a), the sealing mechanism is arranged between the cylindrical part and the rotation output part to seal a space between the cylindrical part and the rotation output part. In a configuration (b), the sealing mechanism is arranged between the rotation output part and the fixed part to seal a space between the rotation output part and the fixed part. Moreover, in the case of the configuration (c), the cylindrical part is split into two bodies in the axial direction, the respective split bodies are respectively formed integrally with the fixed part and the rotation output part, and the sealing mechanism is arranged between the split bodies to seal a space between the split bodies.

In addition, the configuration (a) and the configuration (b) are more suitable than the configuration (c). In the case of the configuration (c), the sealing mechanism is arranged at an axial intermediate position of the cylindrical part. Therefore, the configuration (a) and the configuration (b) in which the sealing mechanism is arranged at the end of the cylindrical part may be used. In the comparison between the configuration (a) and the configuration (b), the configuration (a) is suitable. That is, as the cylindrical part is formed integrally with the fixed part, the inertia of the rotation output part can be made smaller than in the case of the configurations (b) and (c).

Additionally, in the above-described motor, the fixed part may be configured to have a connecting surface connected to a base, the rotation output part may be configured to have a connecting surface connected to an attached rotating body, and at least one of the connecting surface of the fixed part or the connecting surface of the rotation output part may be formed with a groove in which a seal material (an O-ring, a sealing compound, an adhesive, or a calking material) is arranged.

Moreover, in the above-described motor, the sealing mechanism may have a seal material that is arranged between the cylindrical part and the rotation output part to seal a space between the cylindrical part and the rotation output part, and the rotation output part is made of a lightweight material in which hardness of a seal contact surface to be in contact with the seal material is higher than the hardness of parts other than the seal contact surface.

According to this motor, the weight reduction and low inertia of the rotation output part are can be realized while securing the hardness required for the seal contact surface in the rotation output part.

Further, in the above-described motor, at least the seal contact surface of the rotation output part may be subjected to hardness-improving treatment.

Moreover, in the above-described motor, the hardness-improving treatment may be surface treatment.

Furthermore, in the above-described motor, the lightweight material may be an aluminum material.

Moreover, in the above-described motor, the hardness-improving treatment may be heat treatment, and the lightweight material may be carbide duralumin.

Additionally, in the above-described motor, the surface roughness of the seal contact surface may be Ra 0.05 to 1.60, and the fitting between the internal diameter of the seal material and the external diameter of a seal-attached part to which the seal material is attached is an interference fit of 5.0 mm to 25.00 mm.

Moreover, in the above-described motor, a resolver stator may be built inside the motor body, a resolver having a resolver rotor may be built on an outer peripheral side of the resolver stator, and the rotation output part and the resolver rotor may be integrated.

Additionally, in the above-described motor, a groove for a seal material provided in a connecting surface of the rotation output part to an attached rotating body or a connecting surface of the attached rotating body to the rotation output part may be provided closer to the outer peripheral side than the resolver rotor, and an opening may be provided that opens from a rotational axis center of the rotation output part to a portion that leads to the vicinity of the resolver rotor inside the groove.

In addition, in the above-described motor, the sealing mechanism may be configured to have a seal material arranged between the cylindrical part and the rotation output part to seal a space between the cylindrical part and the rotation output part, and the rotation output part may be made of lightweight material in which hardness of a seal contact surface to be in contact with the seal material is higher than the hardness of parts other than the seal contact surface, at least the seal contact surface of the rotation output part may be subjected to hardness-improving treatment, the hardness-improving treatment may be surface treatment, and the lightweight material may be an aluminum material, surface roughness of the seal contact surface may be Ra 0.05 to 1.60, and fitting between an internal diameter of the seal material and an external diameter of a seal-attached part to which the seal material is attached is an interference fit of 5.0 mm to 25.00 mm, a resolver stator may be configure to be built in the motor body, a resolver having a resolver rotor may be configure to be built on an outer peripheral side of the resolver stator, and the rotation output part and the resolver rotor may be configure to be integrated together, and a groove for a seal material provided on a connecting surface of the rotation output part with respect to an attached rotating body or a connecting surface of the attached rotating body to the rotation output part may be provided closer to the outer peripheral side than the resolver rotor, and an opening may be provided to open from a rotational axis center of the rotation output part to a portion that reaches a vicinity of the resolver rotor at an inside of the groove for the seal material.

Additionally, in the above-described motor, the sealing mechanism may be configure to form a liquid entering preventing part that is arranged between the cylindrical part and the rotation output part to prevent a liquid from entering an inside through between the cylindrical part and the rotation output part from an outside.

Further, in the above-described motor, the liquid entering preventing part may be an oil seal.

Furthermore, in the above-described motor, the liquid entering preventing part may be a dust seal.

Moreover, in the above-described motor, the liquid entering preventing part may be a low rotational resistance seal.

Additionally, in the above-described motor, the liquid entering preventing part may further include a labyrinth.

Further, in the above-described motor, the liquid entering preventing part may be a labyrinth.

Moreover, in the above-described motor, an outer edge of the rotation output part may be formed with a peripheral edge that protrudes to the cylindrical part side, and an axial upper end of the cylindrical part is formed with a step that changes an external diameter, and the labyrinth is configured such that a predetermined gap is arranged between an outer peripheral surface of a smaller-diameter portion formed by the step of the cylindrical part and an inner peripheral surface of the peripheral edge of the rotation output part, and a predetermined gap is arranged between a surface of the step, which is a boundary between a larger-diameter portion and the smaller-diameter portion of the cylindrical part, and a lower end surface of the peripheral edge of the rotation output part.

Additionally, in the above-described motor, the external diameter of the smaller-diameter portion of the cylindrical part and an internal diameter of the peripheral edge of the rotation output part may be configured to incline with respect to a rotational axis of the rotation output part to be larger from an axial upper side of the cylindrical part toward an axial lower side of the cylindrical part.

Further, in the above-described motor, the liquid entering preventing part may be configured to include a porous member near the labyrinth.

Furthermore, in the above-described motor, the internal pressure of the motor may be configured to be increased by air purging.

Moreover, in the above-described motor, a space between the connecting surface of the rotation output part with respect to the attached rotating body and the connecting surface of the attached rotating body with respect to the rotation output part may be configured to be sealed.

Additionally in the above-described motor, a groove for the seal material may be provided on the connecting surface of the rotation output part to the attached rotating body or the connecting surface of the attached rotating body to the rotation output part.

Moreover, in the above-described motor, the sealing mechanism may constitute a liquid entering preventing part that is arranged between the cylindrical part and the rotation output part to prevent a liquid from entering the inside through between the cylindrical part and the rotation output part from the outside, and may further include a failure preventing part for preventing failure when the liquid enters the inside.

Additionally in the above-described motor, the failure preventing part may be configured to be either a liquid detecting sensor or a liquid through hole provided in the fixed part provided on an axial lower side of the cylindrical part.

Moreover, in the above-described motor, the fixed part may include an inclined part that inclines with respect to the axial direction of the cylindrical part, and a bottom surface part that horizontally extends from an axial lowermost portion of the inclined part, and the failure preventing part may be installed on the bottom surface part.

Further, in the above-described motor, one bearing may be provided.

Furthermore, in the above-described motor, the sealing mechanism may be configured to include a seal material arranged between the cylindrical part and the rotation output part to seal a space between the cylindrical part and the rotation output part, and the rotation output part may be configured to cover the center hole of the motor body.

Additionally, in the above-described motor, the liquid entering preventing part may constitute a foreign matter entering preventing part for preventing foreign matter from entering the inside through between the cylindrical part and the rotation output part from the outside.

That is, in the above-described motor, the sealing mechanism may constitute a foreign matter entering preventing part that is arranged between the cylindrical part and the rotation output part to prevent foreign matter from entering the inside through between the cylindrical part and the rotation output part from the outside.

Further, in the above-described motor, the foreign matter entering preventing part may be an oil seal.

Furthermore, in the above-described motor, the foreign matter entering preventing part may be a dust seal.

Moreover, in the above-described motor, the foreign matter entering preventing part may be a low rotational resistance seal.

Additionally, in the above-described motor, the liquid entering preventing part may further include a labyrinth.

Further, in the above-described motor, the foreign matter preventing part may be a labyrinth.

Moreover, in the above-described motor, an outer edge of the rotation output part may be formed with a peripheral edge that protrudes to the cylindrical part side, and an axial upper end of the cylindrical part is formed with a step that changes an external diameter, and the labyrinth may be configured such that a predetermined gap is arranged between an outer peripheral surface of a smaller-diameter portion formed by a step of the cylindrical part and an inner peripheral surface of the peripheral edge of the rotation output part, and a predetermined gap is arranged between a surface of the step, which is a boundary between the larger-diameter portion and the smaller-diameter portion of the cylindrical part, and a lower end surface of the peripheral edge of the rotation output part.

Additionally, in the above-described motor, the external diameter of the smaller-diameter portion of the cylindrical part and the internal diameter of the peripheral edge of the rotation output part may incline with respect to a rotational axis of the rotation output part so as to become larger from an axial upper side of the cylindrical part toward an axial lower side thereof.

Further, in the above-described motor, the foreign matter entering preventing part may include a porous member in the vicinity of the labyrinth.

Furthermore, in the above-described motor, the internal pressure of the motor may be increased by air purging.

Moreover, in the above-described motor, a space between the connecting surface of the rotation output part to the attached rotating body and the connecting surface of the attached rotating body to the rotation output part may be sealed.

Additionally in the above-described motor, a groove for the seal material may be provided on the connecting surface of the rotation output part to the attached rotating body or the connecting surface of the attached rotating body to the rotation output part.

Further, in the above-described motor, the motor body may be of an outer rotor type.

If the motor body is of the outer rotor type, this is suitable because wiring within the motor body of a wiring cable is more easily performed than that in a case where the motor body is of an inner rotor type.

Moreover, a positioning device in another embodiment of the present disclosure is driven by the above-mentioned motor.

Additionally, a conveyance device in still another embodiment of the present disclosure uses the above-mentioned motor as a driving source.

### Advantageous Effects of Invention

According to this present disclosure, as compared to the motors described in PTL 1 and PTL 2, it is possible to provide a motor having a small number of parts and being endowed with waterproof performance by a low-cost method, and a positioning device and a conveyance device that are positioned and driven by the motor.

### REFERENCE SIGNS LIST

1: MOTOR BODY
11: CENTER HOLE
12: SEAL MATERIAL
13: LIQUID ENTERING PREVENTING PART
14: POROUS MEMBER
15: FOREIGN MATTER ENTERING PREVENTING PART
2: HOUSING
21: CYLINDRICAL PART
21a: PERIPHERAL EDGE (SEAL-ATTACHED PART)
21c: STEP
22: ROTATION OUTPUT PART
22a: CENTER HOLE (THROUGH HOLE)
22b: PERIPHERAL EDGE
22f: OPENING
22h: SEAL CONTACT SURFACE
23: FIXED PART
23c: CENTER HOLE (THROUGH HOLE)
23d: GROOVE FOR SEAL MATERIAL
31: WIRING CABLE
32: WIRING CABLE
4: MOTOR PART
41: MOTOR ROTOR (ROTOR)
42: MOTOR STATOR (STATOR)
5: RESOLVER
51: RESOLVER ROTOR (ROTOR)
52: RESOLVER STATOR (STATOR)
9: OIL SEAL
10: SEALING MECHANISM
61: BASE
62: TABLE (ATTACHED ROTATING BODY)
63: SEAL MATERIAL
90: FAILURE PREVENTING PART
91: LIQUID DETECTING SENSOR
95: LIQUID THROUGH HOLE
A: MOTOR
L: LABYRINTH

1.-23. (canceled)

24. A motor, comprising:
a motor body having a column shape in which a center hole penetrating in an axial direction is formed; and
a housing for housing the motor body,
wherein the housing includes a cylindrical part configured to cover an outer peripheral surface of the motor body, a rotation output part provided on an upper side of the cylindrical part in the axial direction and fixed to a rotary body of the motor body, and a fixed part provided on a lower side of the cylindrical part in the axial direction of the cylindrical part and fixed to a fixed body of the motor body, and
wherein the housing is configured to be sealed with a sealing mechanism at only one place of the cylindrical part in the axial direction of the cylindrical part, the sealing mechanism being arranged between the cylindrical part and the rotation output part to seal a space between the cylindrical part and the rotation output part,
wherein the sealing mechanism is configured to form a liquid entering preventing part arranged between the cylindrical part and the rotation output part to prevent a liquid from entering an inside through between the cylindrical part and the rotation output part from an outside, and
wherein internal pressure of the motor is configured to be increased by air purging.

25. The motor according to claim 24, wherein an air duct for the air purging is provided on an inner peripheral surface side of the motor body.

26. A motor, comprising:
a motor body having a column shape in which a center hole penetrating in an axial direction is formed; and
a housing for housing the motor body,
wherein the housing includes a cylindrical part configured to cover an outer peripheral surface of the motor body, a rotation output part provided on an upper side of the cylindrical part in the axial direction and fixed to a rotary body of the motor body, and a fixed part provided on a lower side of the cylindrical part in the axial direction of the cylindrical part and fixed to a fixed body of the motor body, and
wherein the housing is configured to be sealed with a sealing mechanism at only one place of the cylindrical part in the axial direction of the cylindrical part, the sealing mechanism being arranged between the cylindrical part and the rotation output part to seal a space between the cylindrical part and the rotation output part,
wherein the sealing mechanism is configured to have a seal material arranged between the cylindrical part and the rotation output part to seal a space between the cylindrical part and the rotation output part, and
wherein the rotation output part is made of a lightweight material in which hardness of a seal contact surface to be in contact with the seal material is higher than the hardness of parts other than the seal contact surface.

27. The motor according to claim 26, wherein at least the seal contact surface of the rotation output part is subjected to hardness-improving treatment.

28. The motor according to claim 26,
wherein the sealing mechanism is configured to have a seal material arranged between the cylindrical part and the rotation output part to seal a space between the cylindrical part and the rotation output part,
wherein the rotation output part is made of a lightweight material in which hardness of a seal contact surface to be in contact with the seal material is higher than the hardness of parts other than the seal contact surface,
wherein at least the seal contact surface of the rotation output part is subjected to hardness-improving treatment,
wherein the hardness-improving treatment is surface treatment, and the lightweight material is an aluminum material,
wherein surface roughness of the seal contact surface is Ra 0.05 to 1.60, and fitting between an internal diameter of the seal material and an external diameter of a seal-attached part to which the seal material is attached is an interference fit of 5.0 mm to 25.00 mm,
wherein a resolver stator is configured to be built in the motor body, a resolver having a resolver rotor is configured to be built on an outer peripheral side of the resolver stator, and the rotation output part and the resolver rotor are configured to be integrated together, and
wherein a groove for the seal material provided on a connecting surface of the rotation output part with respect to an attached rotating body or on a connecting surface of the attached rotating body with respect to the rotation output part is provided closer to the outer peripheral side than to the resolver rotor, and an opening is provided to open from a rotational axis center of the rotation output part to a portion that reaches a vicinity of the resolver rotor at an inside of the groove for the seal material.

29. A motor, comprising:
a motor body having a column shape in which a center hole penetrating in an axial direction is formed; and
a housing for housing the motor body,
wherein the housing includes a cylindrical part configured to cover an outer peripheral surface of the motor body, a rotation output part provided on an upper side of the cylindrical part in the axial direction and fixed to a rotary body of the motor body, and a fixed part provided on a lower side of the cylindrical part in the axial direction of the cylindrical part and fixed to a fixed body of the motor body, and
wherein the housing is configured to be sealed with a sealing mechanism at only one place of the cylindrical part in the axial direction of the cylindrical part, the sealing mechanism being arranged between the cylindrical part and the rotation output part to seal a space between the cylindrical part and the rotation output part,
wherein the sealing mechanism is configured to form a liquid entering preventing part arranged between the cylindrical part and the rotation output part to prevent a liquid from entering an inside through between the cylindrical part and the rotation output part from an outside,
wherein the liquid entering preventing part is either an oil seal and a labyrinth, or a labyrinth,
wherein an outer edge of the rotation output part is formed with a peripheral edge that protrudes to the cylindrical part side, and an axial upper end of the cylindrical part is formed with a step that changes an external diameter, and
wherein the labyrinth is configured such that a predetermined gap is arranged between an outer peripheral surface of a smaller-diameter portion formed by the step of the cylindrical part and an inner peripheral surface of the peripheral edge of the rotation output part, and a predetermined gap is arranged between a surface of the step, which is a boundary between a larger-diameter portion and the smaller-diameter portion of the cylindrical part, and a lower end surface of the peripheral edge of the rotation output part.

30. The motor according to claim 29, wherein the external diameter of the smaller-diameter portion of the cylindrical part and an internal diameter of the peripheral edge of the rotation output part are configured to incline with respect to a rotational axis of the rotation output part to be larger from an axial upper side of the cylindrical part toward an axial lower side of the cylindrical part.

31. A motor, comprising:
a motor body having a column shape in which a center hole penetrating in an axial direction is formed; and
a housing for housing the motor body,
wherein the housing includes a cylindrical part configured to cover an outer peripheral surface of the motor body, a rotation output part provided on an upper side of the cylindrical part in the axial direction and fixed to a rotary body of the motor body, and a fixed part provided on a lower side of the cylindrical part in the axial direction of the cylindrical part and fixed to a fixed body of the motor body, and
wherein the housing is configured to be sealed with a sealing mechanism at only one place of the cylindrical part in the axial direction of the cylindrical part, the sealing mechanism being arranged between the cylindrical part and the rotation output part to seal a space between the cylindrical part and the rotation output part,
wherein the sealing mechanism is configured to form a liquid entering preventing part arranged between the cylindrical part and the rotation output part to prevent a liquid from entering an inside through between the cylindrical part and the rotation output part from an outside, and
wherein a space between the connecting surface of the rotation output part with respect to the attached rotating body and the connecting surface of the attached rotating body with respect to the rotation output part is configured to be sealed.

32. The motor according to claim 24, wherein the liquid entering preventing part is an oil seal.

33. A motor, comprising:
a motor body having a column shape in which a center hole penetrating in an axial direction is formed; and
a housing for housing the motor body,
wherein the housing includes a cylindrical part configured to cover an outer peripheral surface of the motor body, a rotation output part provided on an upper side of the cylindrical part in the axial direction and fixed to a rotary body of the motor body, and a fixed part provided on a lower side of the cylindrical part in the axial direction of the cylindrical part and fixed to a fixed body of the motor body, and
wherein the housing is configured to be sealed with a sealing mechanism at only one place of the cylindrical part in the axial direction of the cylindrical part, the sealing mechanism being arranged between the cylindrical part and the rotation output part to seal a space between the cylindrical part and the rotation output part, and
wherein the sealing mechanism is configured to form a liquid entering preventing part arranged between the cylindrical part and the rotation output part to prevent a liquid from entering an inside through between the cylindrical part and the rotation output part from an outside,
further comprising a failure preventing part configured to prevent a failure when the liquid enters the inside.

34. The motor according to claim 33, wherein the failure preventing part is configured to be either a liquid detecting sensor or a liquid through hole provided in the fixed part provided on an axial lower side of the cylindrical part.

35. A motor, comprising:
a motor body having a column shape in which a center hole penetrating in an axial direction is formed; and
a housing for housing the motor body,
wherein the housing includes a cylindrical part configured to cover an outer peripheral surface of the motor body, a rotation output part provided on an upper side of the cylindrical part in the axial direction and fixed to a rotary body of the motor body, and a fixed part provided on a lower side of the cylindrical part in the axial direction of the cylindrical part and fixed to a fixed body of the motor body, and
wherein the housing is configured to be sealed with a sealing mechanism at only one place of the cylindrical part in the axial direction of the cylindrical part, the sealing mechanism being arranged between the cylindrical part and the rotation output part to seal a space between the cylindrical part and the rotation output part,
wherein the sealing mechanism is configured to form a liquid entering preventing part arranged between the cylindrical part and the rotation output part to prevent a liquid from entering an inside through between the cylindrical part and the rotation output part from an outside,
wherein the liquid entering preventing part is either an oil seal and a labyrinth, or a labyrinth, and
wherein the liquid entering preventing part is configured to include a porous member near the labyrinth.

36. The motor according to claim 24, wherein the liquid entering preventing part is configured to form a foreign matter entering preventing part configured to prevent a foreign matter from entering the inside through between the cylindrical part and the rotation output part from the outside.

37. The motor according to claim 24, wherein the motor body is an outer rotor type.

38. A positioning device to be positioned and driven by the motor according to claim 24.

39. A conveyance device using the motor according to claim 24 as a driving source.
